(19) United States
(12) Patent Application Publication
(10) Pub. No.: US 2011/0043462 A1
(43) Pub. Date: Feb. 24, 2011

(54) TOUCHSCREEN APPARATUS, INTEGRATED CIRCUIT DEVICE, ELECTRONIC DEVICE AND METHOD THEREFOR

(76) Inventors: Ayman Shabra, Woburn, MA (US); Cheng-Yu Chien, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/757,047

(22) Filed: Apr. 9, 2010

Related U.S. Application Data
(60) Provisional application No. 61/236,161, filed on Aug. 24, 2009.

(51) Int. Cl. G06F 3/041

(52) U.S. Cl. 345/173

(57) ABSTRACT

A method for identifying multiple touch user interaction with a touchscreen device. The method includes receiving an indication that a touch has been detected on the touchscreen device, applying a first voltage across a first conductive layer of the touchscreen device and measuring first and second voltage signals at first and second electrical contacts of a second conductive layer of the touchscreen device, applying a second voltage across the second conductive layer of the touchscreen device and measuring third and fourth voltage signals at third and fourth electrical contacts of the first conductive layer of the touchscreen device, and interpreting the user interaction with the touchscreen device and identifying multiple touch gestures based at least partly on at least one of a difference between the first and second voltage signals, and a difference between the third and fourth voltage signals.

### FIELD OF THE INVENTION

The field of this invention relates to a touchscreen apparatus, an integrated circuit device, an electronic device and a method therefor. The invention is applicable to, but not limited to, a method for interpreting user interaction with a touchscreen device.

### BACKGROUND OF THE INVENTION

In the field of electronic consumer devices it is known to provide as part of a user interface a touchscreen. A touchscreen is a display that is provided with a capability of detecting a presence and location of a touch within the display area. Typically, the term ‘touch’ generally refers to touch or contact to the screen by a finger or hand of a user, although touchscreens may also detect other passive objects, such as a stylus or the like. A key advantage of touchscreens over other forms of user interface devices is the ability to enable a user to directly interact with what is being displayed on the screen, rather than indirectly with, say, a mouse, touchpad, keypad, etc. Furthermore, the use of a touchscreen can remove the need for other forms of input device, such as a keypad or other buttons, etc, thereby enabling more space to be given over to the display screen, or enabling the overall size of a device to be reduced.

4-wire resistive touchscreens are commonly used for cost sensitive applications where touch input is desired. This technology allows for the determination of coordinates for a user touch location and the coordinate information may then be used by application software to determine a suitable response to the users input.

FIG. 1 illustrates a simplified exploded view of an example of a known 4-wire resistive touchscreen implementation 100. The 4-wire touchscreen implementation 100 in FIG. 1 comprises two substantially transparent touchscreen layers 110, 120 located over and substantially parallel with, a display 130, for example a liquid crystal display (LCD). A lower surface 112 of the upper touchscreen layer 110, located generally adjacent an upper surface 122 of the lower touchscreen layer 120, is electrically conductive. The upper surface 122 of the lower touchscreen layer 120 is also electrically conductive. Under normal ‘inactive’ conditions the two touchscreen layers 110, 120 are not in contact with one another. However, when a user touches the screen, the force applied by the user causes the upper touchscreen layer 110 to make contact with the lower touchscreen layer 120 at the point of touch (touch location), and an electrical contact is created at this point. Each of the touchscreen layers 110, 120 comprises two electrical contacts 114, 116, 124, 126 located on opposing edges thereof. For one layer, which for the illustrated example comprises the upper touchscreen layer 110, the contacts 114, 116 are orientated in an ‘X’ direction relative to the display 130, whilst for the other layer, which for the illustrated example comprises the lower touchscreen layer 120, the contacts 124, 126 are orientated in a ‘Y’ direction with respect to the display 130. The touchscreen implementation 100 illustrated in FIG. 1 further comprises four switches 140, 142, 144, 146 and an analogue to digital converter (ADC) 150. Switch 140 is connected between a first electrical contact 114 of the upper touchscreen layer 110 and a ground plane 160. Switch 142 is connected to the second electrical contact 116 of the upper touchscreen layer 110 and is configurable to operably couple the second electrical contact 116 of the upper touchscreen layer 110 to either of a supply voltage (VDD) 165 or to an input of the ADC 150. Switch 144 is connected between a first electrical contact 124 of the lower touchscreen layer 120 and the ground plane 160. Switch 146 is connected to the second electrical contact 126 of the lower touchscreen layer 120 and is configurable to operably couple the second electrical contact 126 of the lower touchscreen layer 120 to either the supply voltage (VDD) 165 or to the input of the ADC 150.

When an X coordinate of a touch location is required to be measured, the switches are configured as follows. Switch 140 is configured to be ‘closed’ in order to operably couple the electrical contact 114 to ground 160. The switch 142 is configured to operably couple the second electrical contact 116 of the upper touchscreen layer 110 to the supply voltage (VDD) 165. In this manner, a voltage potential VDD is applied across the upper touchscreen layer 110 (in the X direction). Switch 144 is configured to be ‘open’ in order to disconnect the electrical contact 124 from the ground plane 160. Switch 146 is configured to operably couple the second electrical contact 126 of the lower touchscreen layer 120 to the input of the ADC 150.

In this manner, when a user touches the touchscreen, the pressure exerted by the user at the touch location causes the two touchscreen layers 110, 120 to come into contact with one another, thereby resulting in an electrical connection being created between the upper and lower layers 110, 120. The resistive properties of the lower surface 112 of the upper touchscreen layer 110 cause the surface 112 to act as a potential divider with respect to the voltage potential VDD applied across the upper touchscreen layer 110 (in the X direction). Thus, the resulting voltage at the touch point, which is conveyed (or at least a representation of which is conveyed) to the second electrical contact 126 of the lower touchscreen layer 120 is proportional to the position of the touch location between the first and second electrical contacts 114, 116 of the upper touchscreen layer (i.e. in the X direction). Accordingly, the voltage at the second electrical contact 126 of the lower touchscreen layer 120 provides an indication of the X coordinate of the touch location. This voltage at the second electrical contact 126 of the lower touchscreen layer 120 is converted into a digital value by the ADC 150 to provide an X coordinate value.

When a Y coordinate of a touch location is required to be measured, the switches are configured as follows. Switch 140 is configured to be ‘open’ in order to disconnect the electrical contact 114 of the upper touchscreen layer 110 from ground 160. Switch 142 is configured to operably couple the electrical contact 116 of the upper touchscreen layer 110 to the input of the ADC 150. Switch 144 is configured to be ‘closed’ in order to operably couple the electrical contact 124 of the lower touchscreen layer 120 to ground 160. Switch 146 is configured to operably couple the electrical contact 126 of the lower touchscreen layer 120 to the supply voltage (VDD) 165. In this manner, a voltage potential VDD is applied across the lower touchscreen layer 110 (in the Y direction).

When a user touches the touchscreen, causing an electrical connection between the upper and lower layers 110, 120 at the touch point, the resistive properties of the upper surface 122 of the lower touchscreen layer 120 cause the surface 122 to act as a potential divider with respect to the voltage potential VDD applied across the lower touchscreen layer 120 (in the Y direction). Thus, the resulting voltage at the touch point, which is conveyed (or at least a representation of which is conveyed) to the second electrical contact 116 of the upper touchscreen layer 110 is proportional to the position of the touch location between the first and second electrical contacts 124, 126 of the lower touchscreen layer 120 (i.e. in the Y direction). Accordingly, the voltage at the second electrical contact 116 of the upper touchscreen layer 110 provides an indication of the Y coordinate of the touch location. This voltage at the second electrical contact 116 of the upper touchscreen layer 110 is converted into a digital value by the ADC 150 to provide a Y coordinate value.

The touchscreen implementation 100 illustrated in FIG. 1 provides a low cost solution to implementing a touchscreen, and significantly only requires each touchscreen layer 110, 120 to comprise two electrical contacts 114, 116, 124, 126. However, a problem with this touchscreen implementation 100 is that it is limited to detecting single touches by a user. With the increasing functional requirements of electronic devices, and in particular of mobile communication devices, such as mobile telephone handsets and the like, user inputs are required to provide more sophisticated and dynamic mechanisms for enabling users to interact with the electronic devices. Accordingly, single touch detection may no longer be sufficient for supporting the functional requirements of modern touchscreen devices.

It is known for capacitive touchscreen devices to be used for multi-touch input. Whilst such capacitive touchscreen implementations enable a detection of multiple touch locations, a capacitive touchscreen implementation requires a large number of transparent wires (typically greater than 30) to be placed on the touchscreen glass, with these transparent wires being required to be connected to a control circuit for performing the measurements and determining the coordinates of the touch locations. As a result, such capacitive touchscreen implementations require complicated and costly touchscreen layers and control circuitry.

Thus, a need exists for an improved touchscreen apparatus, an integrated circuit device for use with a touchscreen, an electronic device comprising the touchscreen apparatus and method of operation therefor.

### SUMMARY OF THE INVENTION

Accordingly, the invention seeks to mitigate, alleviate or eliminate one or more of the above mentioned disadvantages singly or in any combination. Aspects of the invention provide a method for interpreting user interaction with a touchscreen device, an integrated circuit device, a touchscreen apparatus and an electronic device comprising such a touchscreen apparatus, and a computer program product comprising executable program code for interpreting user interaction with a touchscreen device.

According to a first aspect of the invention, there is provided a method for identifying multiple touch user interaction with a touchscreen device. The method comprises receiving an indication that a touch has been detected on the touchscreen device, applying a first voltage across a first conductive layer of the touchscreen device and measuring first and second voltage signals at first and second electrical contacts of a second conductive layer of the touchscreen device, applying a second voltage across the second conductive layer of the touchscreen device and measuring third and fourth voltage signals at third and fourth electrical contacts of the first conductive layer of the touchscreen device. The method further comprises processing the first, second, third and fourth voltage signals and interpreting the user interaction with the touchscreen device and identifying multiple touch gestures based at least partly on at least one of: (i) a difference between the first and second voltage signals measured at the first and second electrical contacts of the second conductive layer, and (ii) a difference between the third and fourth voltage signals measured at the third and fourth electrical contacts of the first conductive layer.

Thus, in one example embodiment of the invention, by applying a first voltage across a first conductive layer of the touchscreen device and measuring first and second voltage signals at first and second electrical contacts of a second conductive layer of the touchscreen device, and applying a second voltage across the second conductive layer of the touchscreen device and measuring third and fourth voltage signals at third and fourth electrical contacts of the first conductive layer of the touchscreen device, if a plurality of touches have been made on the touchscreen device at different coordinates, it is possible to detect that a plurality of touches have been made due to the difference between the voltage signals. For example, a determination that multiple touches has been preformed by measuring a difference between first and second voltage signals at the first and second electrical contacts of the second conductive layer and/or the difference between the third and fourth voltage signals measured at the third and fourth electrical contacts of the first conductive layer. Advantageously, such detection of a plurality of touches is achieved using only four electrical contacts, thus enabling a low cost 4-wire resistive touchscreen device to be used within a touchscreen apparatus. Furthermore, only a four terminal (pin) interface with a controller integrated circuit is required, whilst also enabling multiple touch gestures to be detected and interpreted based on differential signals.

According to an optional feature of the invention, the method may comprise applying the first voltage across the third and fourth contacts of the first conductive layer of the touchscreen device in a first direction and measuring the first voltage signal (V_{YP}) at the first electrical contact of the second conductive layer and the second voltage signal (V_{YN}) at the second electrical contact of the second conductive layer. The method may further comprise applying the second voltage across first and second electrical contacts of the second conductive layer of the touchscreen device in a second direction transverse to the first direction and measuring a third voltage signal (V_{XP}) at the third electrical contact of the first conductive layer and a fourth voltage signal (V_{XN}) at the fourth electrical contact of the first conductive layer.

According to an optional feature of the invention, the method may comprise calculating a first difference between the first and second voltage signals measured at the first and second electrical contacts of the second conductive layer and calculating a second difference between the third and fourth voltage signals measured at the third and fourth electrical contacts of the first conductive layer. If the absolute value of the difference between the first and second voltage signals measured at the first and second electrical contacts of the second conductive layer is below a threshold value and the absolute value of the difference between the third and fourth voltage signals measured at the third and fourth electrical contacts of the first conductive layer is below a threshold value, the method may further comprise determining that the detected user interaction comprises a single touch of the touchscreen device. If it is determined that the detected user interaction comprises a single touch of the touchscreen device, the method may further comprise calculating coordinates for the single touch based on the measured voltages

According to an optional feature of the invention, the method may comprise obtaining a plurality of measurements for a number of the first, second third or fourth voltage signals over a period of time and identifying, based at least partly on the measured voltage signals over the period of time, at least one of: two diverging touches; two converging touches; and two rotating touches.

According to an optional feature of the invention, the method may comprise determining whether the results of (V_{XP}−V_{XN}) and (V_{YP}−V_{YN}) over the period of time are increasing. If the results of (V_{XP}−V_{XN}) and (V_{YP}−V_{YN}) over the period of time are increasing, the method may further comprise determining whether at a start and at an end of the period of time (V_{XP}−V_{XN})>0 and (V_{YP}−V_{YN})>0. If at the start and at the end of the period of time (V_{XP}−V_{XN})>0 and (V_{YP}−V_{YN})>0, the method may further comprise identifying that the detected user interaction comprises two diverging touches.

According to an optional feature of the invention, the method may comprise determining whether the results of (V_{XP}−V_{XN}) and (V_{YP}−V_{YN}) over the period of time are increasing. If the results of (V_{XP}−V_{XN}) and (V_{YP}−V_{YN}) over the period of time are increasing, the method may further comprise determining whether at a start and at an end of the period of time (V_{XP}−V_{XN})<0 and (V_{YP}−V_{YN})<0. If (V_{XP}−V_{XN})<0 and (V_{YP}−V_{YN})<0 throughout the period of time, the method further comprises identifying that the detected user interaction comprises two converging touches.

According to an optional feature of the invention, the method may comprise determining whether the results of (V_{XP}−V_{XN}) and (V_{YP}−V_{YN}) over the period of time are decreasing. If the results of (V_{XP}−V_{XN}) and (V_{YP}−V_{YN}) over the period of time are decreasing, the method may further comprise determining whether at a start and at an end of the period of time (V_{XP}−V_{XN})>0 and (V_{YP}−V_{YN})>0. If at the start and at the end of the period of time (V_{XP}−V_{XN})>0 and (V_{YP}−V_{YN})>0, the method may further comprise identifying that the detected user interaction comprises two converging touches.

According to an optional feature of the invention, the method may comprise determining whether the results of (V_{XP}−V_{XN}) and (V_{YP}−V_{YN}) over the period of time are decreasing, and if the results of (V_{XP}−V_{XN}) and (V_{YP}−V_{YN}) over the period of time are decreasing, the method may further comprise determining whether at a start and at an end of the period of time (V_{XP}−V_{XN})<0 and (V_{YP}−V_{YN})<0, and if at the start and at the end of the period of time (V_{XP}−V_{XN})<0 and (V_{YP}−V_{YN})<0, the method may further comprise identifying that the detected user interaction comprises two diverging touches.

According to an optional feature of the invention, the method may comprise identifying that the detected user interaction comprises two rotating touches, if at least one of the following conditions is true:

(V_{XP}−V_{XN})<0 at a start of the period of time and (V_{XP}−V_{XN})>0 at an end of the period of time;

(V_{XP}−V_{XN})>0 at a start of the period of time and (V_{XP}−V_{XN})<0 at an end of the period of time;

(V_{YP}−V_{YN})<0 at a start of the period of time and (V_{YP}−V_{YN})>0 at an end of the period of time; and

(V_{YP}−V_{YN})>0 at a start of the period of time and (V_{YP}−V_{YN})<0 at an end of the period of time.

According to an optional feature of the invention, if a detected user interaction is identified as comprising two rotating touches, the method may comprise determining the direction of rotation of the touches based on whether the results of (V_{XP}−V_{XN}) and (V_{YP}−V_{YN}) over the period of time are increasing or decreasing.

According to a second aspect of the invention, there is provided an integrated circuit device comprising a signal processing module arranged to identify multiple touch user interaction with a touchscreen device. The signal processing module is arranged to receive an indication that a touch has been detected on the touchscreen device, apply a first voltage across a first conductive layer of the touchscreen device and receive a measurement for first and second voltage signals at first and second electrical contacts of a second conductive layer of the touchscreen device, apply a second voltage across the second conductive layer of the touchscreen device and receive measurements for third and fourth voltage signals at third and fourth electrical contacts of the first conductive layer of the touchscreen device. The signal processing module is further arranged to interpret the user interaction with the touchscreen device and identify multiple touch gestures based at least partly on at least one of a difference between the first and second voltage signals measured at the first and second electrical contacts of the second conductive layer, and a difference between the third and fourth voltage signals measured at the third and fourth electrical contacts of the first conductive layer.

According to a third aspect of the invention, there is provided an electronic device comprising a touchscreen device and a signal processing module arranged to identify multiple touch user interaction with the touchscreen device. The signal processing module is arranged to receive an indication that a touch has been detected on the touchscreen device, apply a first voltage across a first conductive layer of the touchscreen device and receive a measurement for first and second voltage signals at first and second electrical contacts of a second conductive layer of the touchscreen device, apply a second voltage across the second conductive layer of the touchscreen device and receive measurements for third and fourth voltage signals at third and fourth electrical contacts of the first conductive layer of the touchscreen device. The signal processing module is further arranged to interpret the user interaction with the touchscreen device and identify multiple touch gestures based at least partly on at least one of a difference between the first and second voltage signals measured at the first and second electrical contacts of the second conductive layer, and a difference between the third and fourth voltage signals measured at the third and fourth electrical contacts of the first conductive layer.

These and other aspects of the invention will be apparent from, and elucidated with reference to, the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding.

FIG. 1 illustrates a simplified exploded view of an example of a typical 4-wire resistive touchscreen implementation.

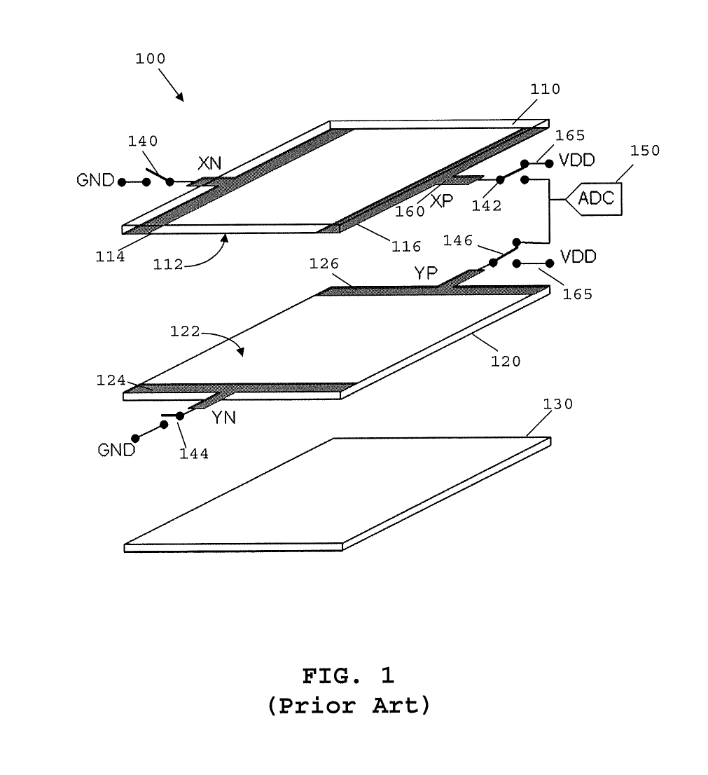

FIG. 2 illustrates a block diagram of an example electronic device that may be adapted to implement the invention.

FIG. 3 illustrates a simplified exploded view of an example of a touchscreen apparatus in a first configuration.

FIG. 4 illustrates an example of a plan view of an example of a touchscreen device of FIG. 3.

FIG. 5 illustrates an example of a simplified electrical circuit created by two touch locations on the touchscreen device of FIG. 3.

FIG. 6 illustrates a simplified exploded view of the example of a touchscreen apparatus of FIG. 3 in an alternative configuration.

FIGS. 7 to 14 illustrate examples of a plan view of multiple touch gestures applied to the touchscreen device of FIG. 3.

FIG. 15 illustrates an example of a simplified flowchart of a method for interpreting user interaction with a touchscreen device.

FIG. 16 illustrates an alternative example of a simplified flowchart of a method for interpreting user interaction with a touchscreen device.

FIG. 17 illustrates a typical computing system that may be employed to implement signal processing functionality in embodiments of the invention.

### DETAILED DESCRIPTION

Examples of the invention will be described in terms of a touchscreen device forming part of a wireless communication unit. However, it will be appreciated by a skilled artisan that the inventive concept herein described may be embodied in any type of electronic device comprising a touchscreen device. In a number of applications, the adaptation of a signal processing module in accordance with the examples of the invention effectively performs a method for identifying multiple touch user interaction with a touchscreen device. The method comprises receiving an indication that a touch has been detected on the touchscreen device, applying a first voltage across a first conductive layer of the touchscreen device and measuring first and second voltage signals at first and second electrical contacts of a second conductive layer of the touchscreen device, applying a second voltage across the second conductive layer of the touchscreen device and measuring third and fourth voltage signals at third and fourth electrical contacts of the first conductive layer of the touchscreen device and interpreting the user interaction with the touchscreen device. The method further comprises identifying multiple touch gestures based at least partly on at least one of a difference between the first and second voltage signals measured at the first and second electrical contacts of the second conductive layer, and a difference between the third and fourth voltage signals measured at the third and fourth electrical contacts of the first conductive layer.

In this manner, a resistive touchscreen device, for example comprising a 4-wire touchscreen display, may be used to provide a cost effective touchscreen implementation within an electronic device, with the ability to identify and interpret multiple touch gestures from a user. Consequently, the simplicity and cost effectiveness of such a resistive touchscreen device may be exploited whilst enabling a more sophisticated and dynamic mechanism with which users are able to interact with the electronic device.

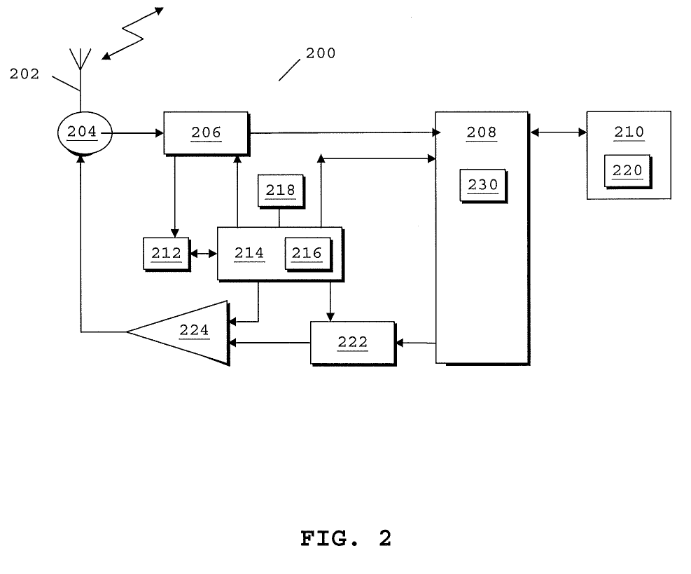

Referring first to FIG. 2, a block diagram of an electronic device in a form of a wireless communication unit 200 (sometimes referred to as a mobile subscriber unit (MS) in the context of cellular communications or a user equipment (UE) in terms of a 3^{rd} generation partnership project (3GPP) communication system) is shown, in accordance with one example embodiment of the invention. The wireless communication unit 200 contains an antenna 202 preferably coupled to a duplex filter or antenna switch 204 that provides isolation between receive and transmit chains within the MS 200.

The receiver chain, as known in the art, includes receiver front-end circuitry 206 (effectively providing reception, filtering and intermediate or base-band frequency conversion). The front-end circuitry 206 is serially coupled to a signal processing module 208. An output from the signal processing module 208 is provided to a suitable output component of a user interface 210. The receiver chain also includes received signal strength indicator (RSSI) circuitry 212, which in turn is coupled to a controller 214 that maintains overall subscriber unit control. The controller 214 may therefore receive bit error rate (BER) or frame error rate (FER) data from recovered information. The controller 214 is also coupled to the receiver front-end circuitry 206 and the signal processing module 208 (generally realised by a digital signal processor (DSP)). The controller is also coupled to a memory device 216 that selectively stores operating regimes, such as decoding/encoding functions, synchronisation patterns, code sequences, RSSI data, and the like.

As regards the transmit chain, this essentially includes one or more input components within the user interface 210, coupled in series through transmitter/modulation circuitry 222 and a power amplifier 224 to the antenna 202. The transmitter/modulation circuitry 222 and the power amplifier 224 are operationally responsive to the controller 214.

The signal processor module 208 in the transmit chain may be implemented as distinct from the processor in the receive chain. Alternatively, a single processor 208 may be used to implement processing of both transmit and receive signals, as shown in FIG. 2. Clearly, the various components within the MS 200 can be realised in discrete or integrated component form, with an ultimate structure therefore being merely an application-specific or design selection.

In accordance with examples of the invention, the user interface 210 comprises a touchscreen display 220 arranged to display information provided thereto by the signal processing module 208, and comprising the capability of detecting the presence and location of a touch within the display area. Typically, the term ‘touch’ generally refers to touch or contact to the screen by a finger or hand of a user, although touchscreens may also detect other passive objects, such as a stylus or the like.

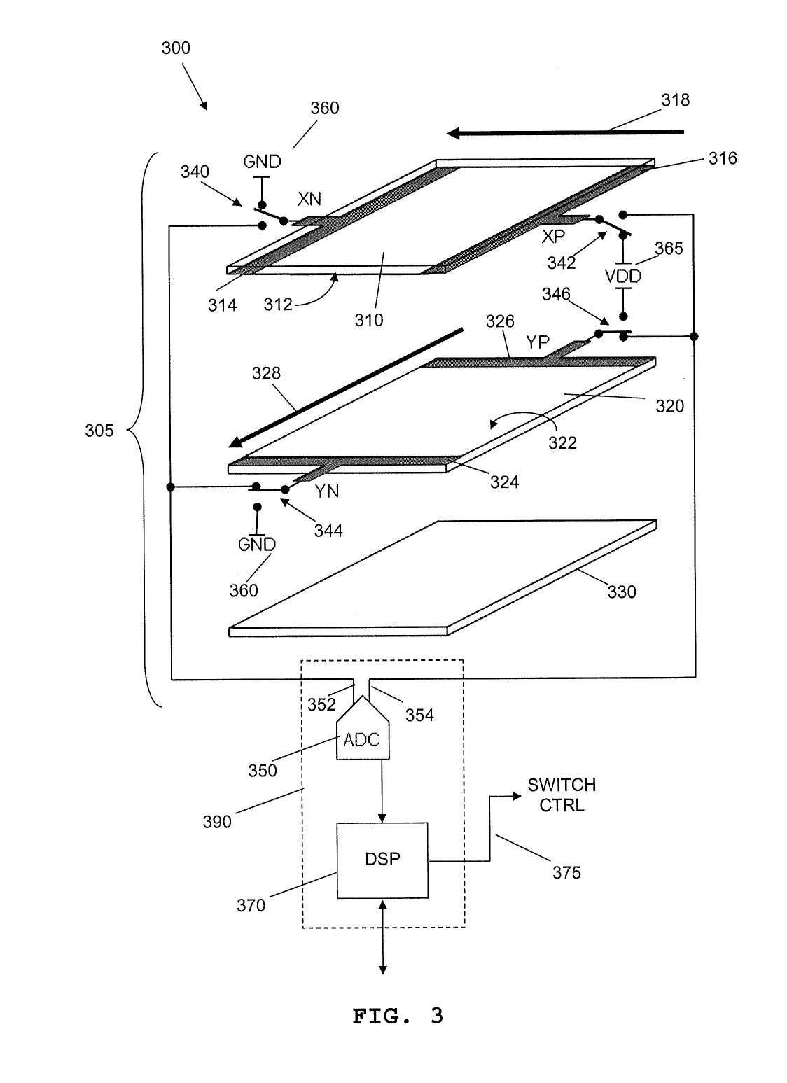

FIG. 3 illustrates a simplified exploded view of an example of a touchscreen apparatus 300, for example as may be used to implement the touchscreen display 220 of the wireless communication unit 200 of FIG. 2. The touchscreen apparatus 300 comprises a touchscreen device 305 and a signal processing module, which for the illustrated example comprises digital signal processor (DSP) 370, arranged to interpret user interaction with the touchscreen device 305. In accordance with examples of the present invention, the DSP 370 is arranged to receive an indication that a touch has been detected on the touchscreen device, to apply a first voltage across a first conductive layer of the touchscreen device and receive a measurement for first and second voltage signals at first and second electrical contacts of a second conductive layer of the touchscreen device. The DSP 370 is further arranged to apply a second voltage across the second conductive layer of the touchscreen device and receive measurements for third and fourth voltage signals at third and fourth electrical contacts of the first conductive layer of the touchscreen device, and interpret the user interaction with the touchscreen device and identify multiple touch gestures based at least partly on at least one of a difference between the first and second voltage signals measured at the first and second electrical contacts of the second conductive layer, and a difference between the third and fourth voltage signals measured at the third and fourth electrical contacts of the first conductive layer.

A touch may be detected on the touchscreen in any suitable manner. For example, one of the touchscreen conductive layers may be connected to a pull-up current source, whilst the other conductive layer is grounded. In the event of a touch, the current source terminal voltage will go to ground and this change in voltage may be detected, for example using a simple comparator.

For the illustrated example, the touchscreen device 310 for the illustrated example comprises two substantially transparent touchscreen layers 310, 320 located over a display element 330, for example a liquid crystal display. A lower surface 312 or the upper touchscreen layer 310, located generally adjacent an upper surface 322 of the lower touchscreen layer 320 is electrically conductive. The upper surface 322 of the lower touchscreen layer 320 is also electrically conductive. The upper and lower touchscreen layers 310, 320 may, in use, be separated by, for example, an air gap or micro dots. Under normal ‘inactive’ conditions, the two touchscreen layers 310, 320 are not in contact with one another. However, when a user ‘touches’ or otherwise exerts sufficient pressure on a region of a display area of the touchscreen device 305, the pressure applied by the user causes the upper touchscreen layer 310 to make contact with the lower touchscreen layer 320 at the point of touch (touch location), and an electrical contact between the upper and lower touchscreen layers 310, 320 is created.

Accordingly, the DSP 370 for the illustrated example is arranged, upon receipt of an indication that a touch has been detected on the touchscreen device 305, to apply a first voltage across the upper touchscreen layer 310 and receive a measurement for first and second voltage signals at first and second electrical contacts, which for the illustrated example comprise contacts (YN, YP) 324, 326 of the lower touchscreen layer 320, to apply a second voltage across the lower touchscreen layer 320 and receive a measurement for third and fourth voltage signals at third and fourth electrical contacts, which for the illustrated example comprise contacts (XN, XP) 314, 316 of the upper touchscreen layer 310, and to interpret the user interaction with the touchscreen device 305 based at least partly on a difference between the first and second voltage signals measured at the electrical contacts (YN, YP) 324, 326 of the lower touchscreen layer 320 and/or on a difference between the third and fourth voltage signals measured at the electrical contacts (XN, XP) 314, 316 of the upper touchscreen layer 310. It will be appreciated that a voltage may be applied to one layer and then the other layer in either order.

For the illustrated example, each of the first and second touchscreen layers 310, 320 comprises two electrical contacts (XN, XP) 314, 316 and (YN, YP) 324, 326 respectively provided on generally opposing edges thereof. The touchscreen layers 310, 320 are orientated such that the contacts (XN, XP) 314, 316 of the first touchscreen layer 310 are aligned in a first direction, illustrated generally at 318, and the contacts (YN, YP) 324, 326 of the second touchscreen layer 320 are aligned in a second direction, illustrated generally at 328, transverse to the first direction 318. For the illustrated example, the first and second directions 318, 328 in which the electrical contacts 314, 316, 324, 326 are aligned are substantially orthogonal with respect to one another.

The touchscreen apparatus 300 of FIG. 3 further comprises switching circuitry comprising four switches 340, 342, 344, 346, and an analogue to digital converter (ADC) 350. A first switch 340 is connected to the first electrical contact (XN) 314 of the upper touchscreen layer 310, and arranged to operably couple the first electrical contact (XN) 314 of the upper touchscreen layer 310 to either of a ground plane 360 and a first input 352 of the ADC 350. A second switch 342 is connected to the second electrical contact (XP) 316 of the upper touchscreen layer 310, and arranged to operably couple the second electrical contact (XP) 316 of the upper touchscreen layer 310 to either of a voltage supply (VDD) 365 and a second input 354 of the ADC 350. A third switch 344 is connected to the first electrical contact (YN) 324 of the lower touchscreen layer 320, and arranged to operably couple the first electrical contact (YN) 324 of the lower touchscreen layer 320 to either of the ground plane 360 and the first input 352 of the ADC 350. A fourth switch 346 is connected to the second electrical contact (YP) 326 of the lower touchscreen layer 320, and arranged to operably couple the second electrical contact (YP) 326 to either of the voltage supply (VDD) 365 and the second input 354 of the ADC 350.

Accordingly, the DSP 370 is operably coupled to the switches 340, 342, 344, 346 via one or more switch control signals, illustrated generally at 375, and arranged to configure the switches 340, 342, 344, 346 to comprise one of a first ‘X-scan’ configuration or a second ‘Y-scan’ configuration. In the first X-scan configuration, and as illustrated in FIG. 3, the first switch 340 is configured to operably couple the first electrical contact 314 of the upper touchscreen layer 310 to the ground plane 360. The second switch 342 is configured to operably couple the second electrical contact 316 of the upper touchscreen layer 310 to the voltage supply 365. The third and fourth switches 344, 346 are configured to operably couple the electrical contacts 324, 326 of the lower touchscreen layer 320 to the ADC 350.

In this manner, by configuring the first and second switches 340, 342 to operably couple the first and second contacts 314, 316 of the upper touchscreen layer 310 to ground 360 and the supply voltage 365 respectively, the DSP 370 applies a first voltage across the contacts 314, 316 of the upper touchscreen layer 310 in the first direction 318. Conversely, by configuring the third and fourth switches 344, 346 to operably couple the contacts 324, 326 of the lower touchscreen layer 320 to the ADC 350, the ADC 350 is able to convert voltage signals for the contacts 324, 326 of the lower touchscreen layer 320 into voltage measurements therefor, and to provide the voltage measurements to the DSP 370.

For the illustrated example, the DSP 370 and ADC 350 are provided within an integrated circuit device 390.

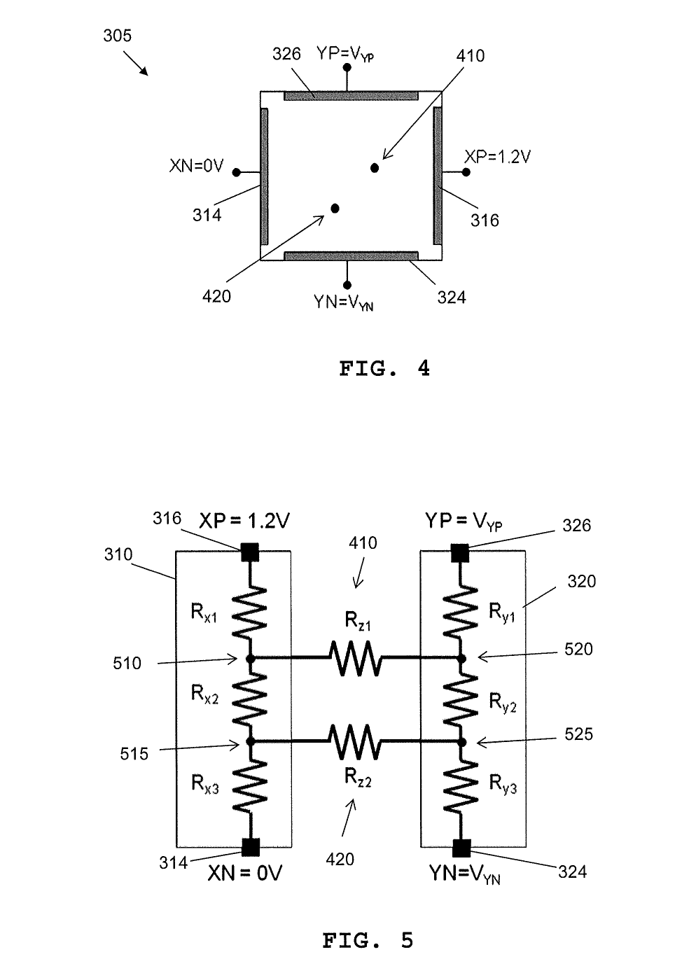

FIG. 4 illustrates an example of a plan view of the touchscreen device 305 of FIG. 3 in which the upper touchscreen layer 310 is orientated such that the contacts 314, 316 are generally aligned along an x-axis for the touchscreen device 305 (e.g. horizontally). The lower touchscreen layer 320 is orientated such that the contacts 324, 326 are generally aligned along a y-axis for the touchscreen device 305 (e.g. vertically). The switches 340, 342, 344, 346 are configured in the X-scan configuration described above. For the example illustrated in FIG. 4, a supply voltage 365 of, say, 1.2 v is applied to the second contact (XP) 316 of the upper touchscreen layer 310, whilst the first contact (XN) 314 of the upper touchscreen layer 310 is operably coupled to a lower potential, e.g. ground 360, illustrated as 0 v. Illustrated at 410, 420 are two touch locations where a user touches and exerts pressure on the touchscreen device 305 at two points. At each of the touch locations 410, 420, the upper touchscreen layer 310 comes into contact with the lower touchscreen layer 320, thereby creating two electrical connections there between.

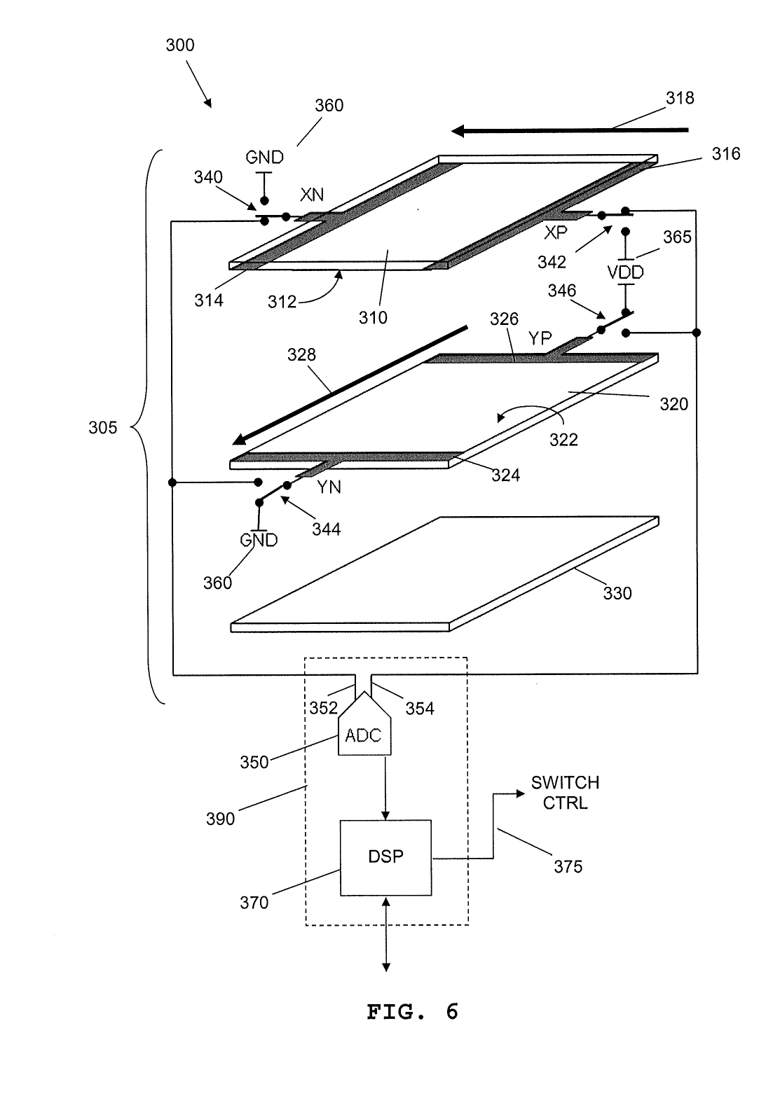

FIG. 5 illustrates an example of a simplified electrical circuit created by two such touch locations 410, 420 on the touchscreen device 305. The upper touchscreen layer 310 may be expressed as a voltage divider comprising a first resistance (Rₓ₁) between the electrical contact 316 to which the 1.2 v supply voltage is applied and the first touch point 410 closest to the electrical contact 316, a second resistance (Rₓ₂) between the first touch point 410 and the second touch point 420, and a third resistance (Rₓ₃) between the second touch point 420 and the electrical contact 314. Accordingly, each touch point 410, 420 comprises a voltage value corresponding to its respective node 510, 515 within the voltage divider arrangement. Since the values of the resistances (Rₓ₁), (Rₓ₂) and (Rₓ₃) within the voltage divider arrangement are dependent upon the resistive characteristics of the touchscreen layer 310 and the distances between the touch points 410, 420 and the electrical contacts 314, 316 as well as with respect to each other, the voltage values at each touch point 410, 420 will also be dependent upon the distances between the touch points 410, 420 and the contact points 314, 316. Accordingly, when the upper touchscreen layer 310 is ‘energised’, i.e. when a voltage is applied across the electrical contacts 314, 316 as illustrated in FIGS. 3, 4 and 5, the voltage values at the touch points 410, 420 on the upper touchscreen layer 310 will be representative of the locations of the touches with respect to the electrical contacts 314, 316, and more particularly with respect to the x-axis for the touchscreen device 305. Assuming that the two touch points comprise different ‘x’ coordinates on the touchscreen device 305, their respective voltage values on the upper touchscreen layer 310 will be different.

At each touch point 410, 420, the contact made between the upper touchscreen layer 310 and the lower touchscreen layer 320 comprises a ‘touch’ resistance (R_{z1}), (R_{z2}). In a similar manner to the voltage divider arrangement of the upper touchscreen layer 310, a resistive network, comprising resistances (R_{y1}), (R_{y2}) and (R_{y3}), is created by the lower touchscreen layer 320 between nodes 520, 525, corresponding to the contact points made with the upper touchscreen layer 310 at the touch points 410, 510, and the electrical contacts 324, 326 or the lower touchscreen layer 320. Accordingly, assuming a high load resistance is provided at each of the electrical contacts 324, 326 of the lower touchscreen layer 320, the voltage values (V_{YN}), (V_{YP}) at the electrical contacts 324, 326 will be representative of the voltage values at the nodes 510, 515 of the potential divider arrangement of the upper touchscreen layer 310, and thus of the locations of the touches with respected to the contact points 314, 316, and more particularly with respect to the x-axis for the touchscreen device 305.

Accordingly, by measuring the voltage signals (V_{YN}), (V_{YP}) at the electrical contacts 324, 326 of the lower touchscreen layer 320, when a voltage is applied across the electrical contacts 314, 316 of the upper touchscreen layer 310 in this manner, it is possible to detect a touch on the touchscreen device 305. Additionally, if a plurality of touches have been made on the touchscreen device 305, and assuming that the plurality of touches comprise different ‘x’ coordinates, it is possible to detect that a plurality of touches have been made due to the difference in the voltage signals (V_{YN}), (V_{YP}) measured at the electrical contacts 324, 326.

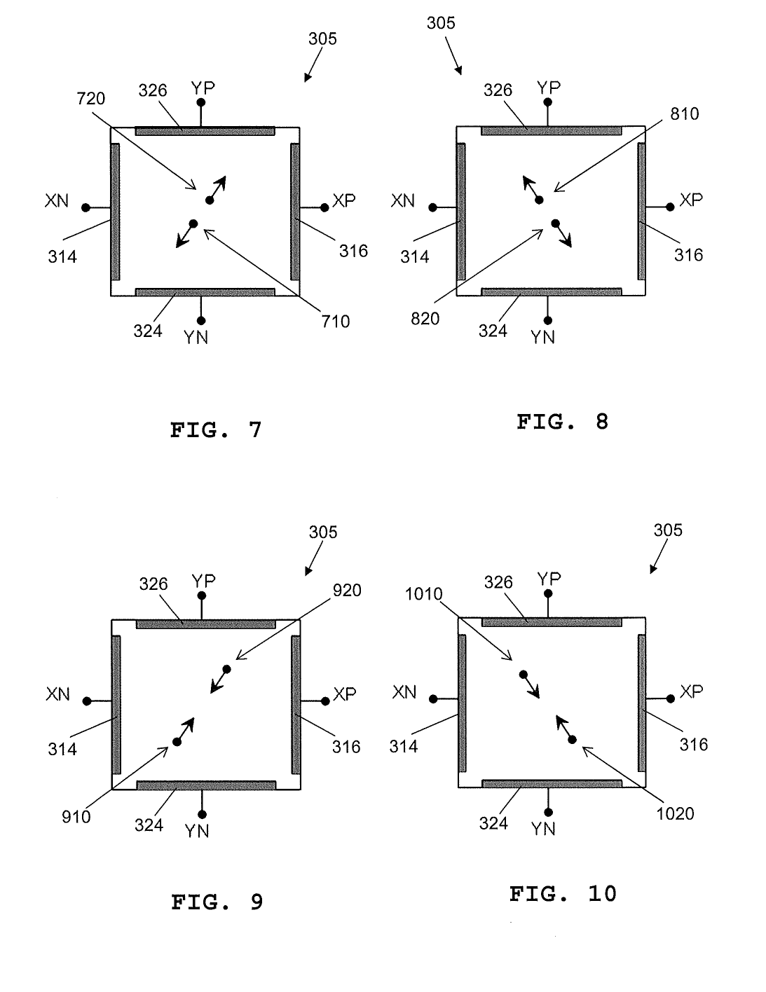

Referring now to FIG. 6, the touchscreen apparatus 300 is illustrated with the switches 340, 342, 344, 346 configured to comprise the second ‘Y-scan’ configuration. In this Y-scan configuration, the first and second switches 340, 342 are configured to operably couple the electrical contacts 314, 316 of the upper touchscreen layer 310 to the ADC 350. The third switch 344 is configured to operably couple the first electrical contact 324 of the lower touchscreen layer 310 to the ground plane 360. The fourth switch 346 is configured to operably couple the second electrical contact 326 of the lower touchscreen layer 320 to the voltage supply 365.

In this manner, by configuring the third and fourth switches 344, 346 to operably couple the first and second contacts 324, 326 of the lower touchscreen layer 320 to ground 360 and the supply voltage 365 respectively, the DSP 370 applies a voltage across the first and second contacts 324, 326 of the lower touchscreen layer 320 in the second direction 328. Conversely, by configuring the first and second switches 340, 342 to operably couple the contacts 314, 316 of the upper touchscreen layer 310 to the ADC 350, the ADC 350 is able to convert voltage signals for the contacts 314, 316 of the upper touchscreen layer 310 into voltage measurements therefor, and to provide the voltage measurements to the DSP 370.

In a similar manner as described above with respect to FIG. 5, when the switches 340, 342, 344, 346 are configured to comprise the second ‘Y-scan’ configuration, the lower touchscreen layer 320 may be expressed as a voltage divider when one or more touches are made on the touchscreen device 305. Accordingly, each touch point comprises a voltage value corresponding to its respective node within the voltage divider arrangement. Since the values of the resistances within the voltage divider arrangement are dependent upon the resistive characteristics of the lower touchscreen layer 320 and the distances between the touch points and the contact points 324, 326 and with respect to each other, the voltage values at each touch point will also be dependent upon the distances between the touch points and the electrical contacts 324, 326. Accordingly, when the lower touchscreen layer 320 is ‘energised’, i.e. when a voltage is applied across the electrical contacts 324, 326 as illustrated in FIG. 6, the voltage values at the touch points on the lower touchscreen layer 320 will be representative of the locations of the touches with respected to the electrical contacts 324, 326, and more particularly with respect to the y-axis for the touchscreen device 305. Assuming the two touch points comprise different ‘y’ coordinates on the touchscreen device 305, their respective voltage values on the lower touchscreen layer 320 will be different.

A resistive network is created by the upper touchscreen layer 310 between nodes corresponding to contact points made with the lower touchscreen layer 320 at the touch points and the electrical contacts 314, 316 or the upper touchscreen layer 310. Accordingly, assuming a high load resistance is provided at each of the electrical contacts 314, 316 of the upper touchscreen layer 310, the voltage values (V_{XN}), (V_{XP}) at the electrical contacts 314, 316 will be representative of the voltage values at the nodes of the potential divider arrangement of the lower touchscreen layer 320, and thus of the locations of the touches with respect to the contact points 324, 326, and more particularly with respect to the y-axis for the touchscreen device 305.

Accordingly, by measuring the voltage signals (V_{XN}), (V_{XP}) at the electrical contacts 314, 316 of the upper touchscreen layer 310 when a voltage is applied across the electrical contacts 324, 326 of the lower touchscreen layer 320 in this manner, it is possible to detect a touch on the touchscreen device 305. It is also possible to detect whether a plurality of touches have been made on the touchscreen device 305. Assuming that the plurality of touches comprise different ‘y’ coordinates, it is possible to detect that a plurality of touches have been made by calculating a difference in the voltage signals (V_{XN}), (V_{XP}) measured at the electrical contacts 314, 316.

Thus, the first and second voltage signals (V_{YN}), (V_{YP}) at the electrical contacts 324, 326 of the lower touchscreen layer 320 (first and second electrical contacts) are measured and a difference between the first and second voltage signals measured at the first and second electrical contacts 324, 326 of the lower conductive layer 320 are calculated. The measured values for third and fourth voltage signals (V_{XN}), (V_{XP}) at the electrical contacts 314, 316 of the upper touchscreen layer 310 (third and fourth electrical contacts) are compared and a difference between the third and fourth voltage signals measured at the third and fourth electrical contacts of the upper conductive layer 310 are calculated. If the absolute value of the difference between the first and second voltage signals measured at the first and second electrical contacts of the lower conductive layer is below a threshold value AND the absolute value of the difference between the third and fourth voltage signals measured at the third and fourth electrical contacts of the upper conductive layer is below a threshold value, it may be determined that a detected user interaction comprises a single touch on the touchscreen device 305. It will be appreciated that, since an object used to interact with the touchscreen device 305 may comprise a relatively large surface area, for example a finger tip or the like, such a single touch may cover a significant amount of surface area of the touchscreen device. Accordingly, there may be a small difference between the first and second voltage signals and third and fourth voltage signals measured.

Conversely, if the measured values for the first and second voltage signals (V_{YN}), (V_{YP}) at the electrical contacts 324, 326 of the lower touchscreen layer 320 are substantially different and/or the third and fourth voltage signals (V_{XN}), (V_{XP}) at the electrical contacts 314, 316 of the upper touchscreen layer 310 are substantially different, it may be determined that the detected user interaction comprises multiple touches of the touchscreen device 305. If it is determined that the detected user interaction comprises a single touch of the touchscreen device 305, the coordinates for the single touch may be calculated based on the measured voltage signals (V_{XN}), (V_{XP}), (V_{YN}), (V_{YP}) at the electrical contacts 314, 316, 324, 326 in accordance with known techniques, which will not be described further.

For the example illustrated in FIG. 3, the DSP 370 is arranged to apply a first voltage comprising the supply voltage (VDD) 365 across the contacts 314, 316 of the upper touchscreen layer 310. The DSP 370 is further arranged to apply a second voltage also comprising the supply voltage (VDD) 365 across the contacts 324, 326 of the lower touchscreen layer 320. In this manner, a common voltage is used to for the first and second voltages applied across the touchscreen layers 310, 320. However, it is contemplated that different voltages may be used for the first and second voltages applied across the two touchscreen layers. For example, in a case where the touchscreen apparatus comprises a first dimension (e.g. along the x-axis) significantly greater in length than a second dimension (e.g. along the y-axis), a larger voltage may be applied across one of the touchscreen layers along the x-axis direction, in order to allow for greater resolution over the greater length.

In accordance with some examples of the present invention, if it is determined that a detected user interaction comprises multiple touches on the touchscreen device 305, the DSP 370 may be arranged to indentify one or more multiple touch gestures based at least partly on measurements for the voltage signals (V_{XN}), (V_{XP}), (V_{YN}), (V_{YP}) at the electrical contacts 314, 316, 324, 326. For example, the DSP 370 may be arranged to obtain a plurality of measurements for a number of the voltage signals (V_{XN}), (V_{XP}), (V_{YN}), (V_{YP}) at the electrical contacts 314, 316, 324, 326 over a period of time, and to identify one or more multiple touch gestures based at least partly on the measured voltage signals (V_{XN}), (V_{XP}), (V_{YN}), (V_{YP}) at the electrical contacts 314, 316, 324, 326 over the period of time. In particular, the DSP 370 may be arranged to obtain a plurality of measurements for a number of the voltage signals (V_{XN}), (V_{XP}), (V_{YN}), (V_{YP}) at the electrical contacts 314, 316, 324, 326 over a period of time and identify diverging touches, converging touches, and/or rotating touches, based at least partly on the measured voltage signals (V_{XN}), (V_{XP}), (V_{YN}), (V_{YP}) over the period of time.

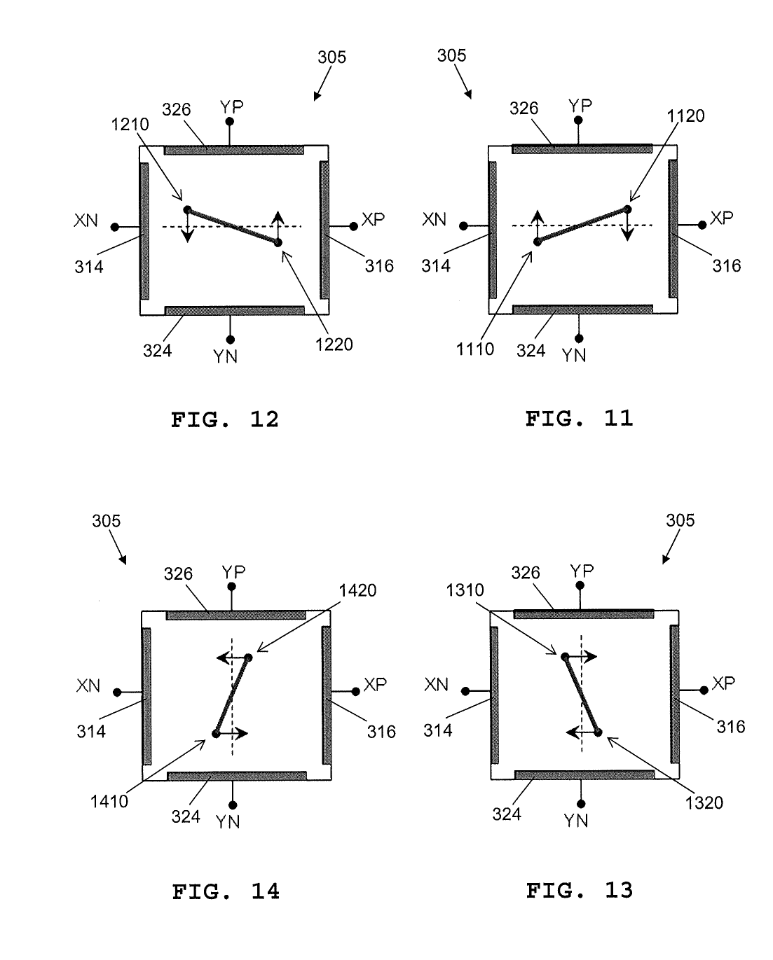

FIG. 7 illustrates an example of a plan view of a multiple touch gesture applied to the touchscreen device 305 of FIG. 3. The multiple touch gesture illustrated in FIG. 7 comprises two touches originating at points 710, 720 and moving away from each other (diverging). In particular for the example illustrated in FIG. 7, the points 710, 720 at which the two touches originate are orientated in a diagonal manner (lower left to upper right) such as may be representative of the use of a thumb and index finger of the right hand of a user, and comprise a diverging movement representative of the user moving their right thumb and index finger apart.

FIG. 8 illustrates an alternative example of a plan view of a multiple touch gesture applied to the touchscreen device 305 of FIG. 3. The multiple touch gesture illustrated in FIG. 8 comprises two touches originating at points 810, 820 and moving away from each other (diverging). In particular for the example illustrated in FIG. 8, the points 810, 820 at which the two touches originate are orientated in a diagonal manner (upper left to lower right) such as may be representative of the use of a thumb and index finger of the left hand of a user, and comprise a diverging movement representative of the user moving their left thumb and index finger apart.

Such diverging multiple touch gestures may be used to provide, say, a ‘zoom in’ input mechanism, and may be identified by detecting, for example, an increase in the difference between the measured values for the voltage signals (V_{XN}), (V_{XP}) at the electrical contacts 314, 316, and an increase in the difference between the measured values for the voltage signals (V_{YN}), (V_{YP}) at the electrical contacts 324, 326. For example, the DSP 370 may be arranged to obtain a plurality of measurements for each of the voltage signals (V_{XN}), (V_{XP}), (V_{YN}), (V_{YP}) at the electrical contacts 314, 316, 324, 326 over a period of time. The DSP 370 may then be arranged to determine whether the results of (V_{XP}−V_{XN}) and (V_{YP}−V_{YN}) over the period of time are increasing or decreasing. If the results of (V_{XP}−V_{XN}) and (V_{YP}−V_{YN}) over the period of time are increasing, the DSP 370 may be arranged to determine whether at a start and at an end of the period of time (V_{XP}−V_{XN})>0 and (V_{YP}−V_{YN})>0. If at the start and at the end of the period of time (V_{XP}−V_{XN})>0 and (V_{YP}−V_{YN})>0, the DSP 370 may identify that the detected user interaction comprises two diverging touches (for example as effected by a user's right hand). Alternatively, if the results of (V_{XP}−V_{XN}) and (V_{YP}−V_{YN}) over the period of time are decreasing, the DSP 370 may be arranged to determine whether at a start and at an end of the period of time (V_{XP}−V_{XN})<0 and (V_{YP}−V_{YN})<0. If at the start and at the end of the period of time (V_{XP}−V_{XN})<0 and (V_{YP}−V_{YN})<0, the DSP 370 may identify that the detected user interaction comprises two diverging touches (for example as effected by a user's left hand).

In the case where such diverging multiple touch gestures are used to provide, say, a ‘zoom in’ input mechanism, the measurements for each of the voltage signals (V_{XN}), (V_{XP}), (V_{YN}), (V_{YP}) at the electrical contacts 314, 316, 324, 326 may be used to determine a focal point at which to centre the zoom function. For example, an average of an initial set of measured values for the voltage signals (V_{XN}), (V_{XP}) at the electrical contacts 314, 316 (e.g. those measured towards the start of the period of time) may be used to determined an ‘x’ coordinate for the zoom focal point, whist an average of an initial set of measured values for the voltage signals (V_{YN}), (V_{YP}) at the electrical contacts 324, 326 may be used to determine a ‘y’ coordinate for the zoom focal point.

FIG. 9 illustrates a further alternative example of a plan view of a multiple touch gesture applied to the touchscreen 305 of FIG. 3. The multiple touch gesture illustrated in FIG. 9 comprises two touches originating at points 910, 920 and moving towards each other (converging). In particular for the example illustrated in FIG. 9, the points 910, 920 at which the two touches originate are orientated in a diagonal manner (lower left to upper right), such as may be representative of the use of a thumb and index finger of the right hand of a user, and comprise a converging movement representative of the user moving their right thumb and index finger together.

FIG. 10 illustrates a still further alternative example of a plan view of a multiple touch gesture applied to the touchscreen 305 of FIG. 3. The multiple touch gesture illustrated in FIG. 10 comprises two touches originating at points 1010, 1020 and moving towards each other (converging). In particular for the example illustrated in FIG. 10, the points 1010, 1020 at which the two touches originate are orientated in a diagonal manner (upper left to lower right), such as may be representative of the use of a thumb and index finger of the left hand of a user, and comprise a converging movement representative of the user moving their left thumb and index finger together.

Such converging multiple touch gestures may be used to provide, say, a ‘zoom out’ input mechanism, and may be identified by detecting, for example, a decrease in the difference between the measured values for the voltage signals (V_{XN}), (V_{XP}) at the electrical contacts 314, 316, and a decrease in the difference between the measured values for the voltage signals (V_{YN}), (V_{YP}) at the electrical contacts 324, 326. For example, the DSP 370 may be arranged to obtain a plurality of measurements for each of the voltage signals (V_{XN}), (V_{XP}), (V_{YN}), (V_{YP}) at the electrical contacts 314, 316, 324, 326 over a period of time. The DSP 370 may then be arranged to determine whether the results of (V_{XP}−V_{XN}) and (V_{YP}−V_{YN}), over the period of time, are increasing or decreasing. If the results of (V_{XP}−V_{XN}) and (V_{YP}−V_{YN}) over the period of time are increasing, the DSP 370 may be arranged to determine whether, at a start and at an end of the period of time, (V_{XP}−V_{XN})<0 and (V_{YP}−V_{YN})<0. If at the start and at the end of the period of time (V_{XP}−V_{XN})<0 and (V_{YP}−V_{YN})<0, the DSP 370 may identify that the detected user interaction comprises two converging touches (for example as effected by a user's left hand). Alternatively, if the results of (V_{XP}−V_{XN}) and (V_{YP}−V_{YN}) over the period of time are decreasing, the DSP 370 may be arranged to determine whether at a start and at an end of the period of time (V_{XP}−V_{XN})>0 and (V_{YP}−V_{YN})>0. If at the start and at the end of the period of time (V_{XP}−V_{XN})>0 and (V_{YP}−V_{YN})>0, the DSP 370 may identify that the detected user interaction comprises two converging touches (for example as effected by a user's right hand).

In the case where such converging multiple touch gestures are used to provide, say, a ‘zoom out’ input mechanism, the measurements for each of the voltage signals (V_{XN}), (V_{XP}), (V_{YN}), (V_{YP}) at the electrical contacts 314, 316, 324, 326 may be used to determine a focal point at which to centre the zoom function. For example, an average of a later set of measured values for the voltage signals (V_{XN}), (V_{XP}) at the electrical contacts 314, 316 (e.g. those measured towards the end of the period of time) may be used to determined an ‘x’ coordinate for the zoom focal point, whist an average of a later set of measured values for the voltage signals (V_{YN}), (V_{YP}) at the electrical contacts 324, 326 may be used to determine a ‘y’ coordinate for the zoom focal point.

Referring now to FIG. 11, there is illustrated a still further example of a plan view of a multiple touch gesture applied to the touchscreen device 305 of FIG. 3. The multiple touch gesture illustrated in FIG. 11 comprises two touches originating at points 1110, 1120, and initially orientated in a diagonal manner with point 1110 being located at a generally lower left location and with point 1120 being located at a generally upper right location. The two touches comprise a movement whereby the first touch originating at point 1110 moves in a generally upward direction whilst the second touch originating at point 1120 moves in a generally downward direction, such that the touches are subsequently orientated in an opposing diagonal manner, with the touch originating at point 1110 being subsequently located at a generally upper left location and with the touch originating at point 1120 being subsequently located at a generally lower right location, such as may be generally representative of a partial rotation of the two touches in a general clockwise direction. As illustrated in FIG. 11, in their initial locations the touch originating at point 1110 is located closer to the first electrical contact 324 of the lower touchscreen layer 320, whilst the touch originating at point 1120 is located closer to the second electrical contact 326 of the lower touchscreen layer 320. However, during the multiple touch gesture, the order of the two touches with respect to, in the case of the illustrated example, the y-axis is switched. This results in the touch originating at point 1110 subsequently becoming located closer to the second electrical contact 326 of the lower touchscreen layer 320, whilst the touch originating at point 1120 subsequently becomes located closer to the first electrical contact 324 of the lower touchscreen layer 320.

Referring now to FIG. 12, there is illustrated a still further example of a plan view of a multiple touch gesture applied to the touchscreen device 305 of FIG. 3. The multiple touch gesture illustrated in FIG. 12 comprises two touches originating at points 1210, 1220, and initially orientated in a diagonal manner with point 1210 being located at a generally upper left location and with point 1220 being located at a generally lower right location. The two touches comprise a movement whereby the first touch originating at point 1210 moves in a generally downward direction whilst the second touch originating at point 1220 moves in a generally upward direction. The touches are subsequently orientated in an opposing diagonal manner with the touch originating at point 1210 being subsequently located at a generally lower left location and the touch originating at point 1220 being subsequently located at a generally upper right location, such as may be generally representative of a partial rotation of the touches in a general counter clockwise direction. As illustrated in FIG. 12, in their initial locations the touch originating at point 1210 is located closer to the second electrical contact 326 of the lower touchscreen layer 320, whilst the touch originating at point 1220 is located closer to the first electrical contact 324 of the lower touchscreen layer 320. However, during the multiple touch gesture, the order of the two touches with respect to, in the case of the illustrated example, the y-axis is switched resulting in the touch originating at point 1210 subsequently becoming located closer to the first electrical contact 324 of the lower touchscreen layer 320, whilst the touch originating at point 1220 subsequently becomes located closer to the second electrical contact 326 of the lower touchscreen layer 320.

Such rotational multiple touch gestures as illustrated in FIGS. 11 and 12 may be identified by detecting the crossing of the touches with respect to the y-axis. For the example illustrated in FIG. 11, the switches 340, 342, 344, 346 of the touchscreen apparatus 300 are configured in the Y-scan configuration, such that a voltage is applied across the lower touchscreen layer 320. Since the touch originating at point 1110 is located closer to the first electrical contact 314 of the upper touchscreen layer, a voltage signal (V_{XN}) measured at the first electrical contact 314 provides an indication of the position of the touch originating at point 1110 with respect to the y-axis. A voltage signal (V_{XP}) measured at the second electrical contact 316 of the upper touchscreen layer 310 provides an indication of the position of the touch originating at point 1120 with respect to the y-axis. Since the touch originating at point 1110 is initially located closer to the first electrical contact 324 of the lower touchscreen layer 320 (which is operably coupled to ground during the Y-scan), the voltage signal (V_{XN}) initially measured at the first electrical contact 314 of the upper touchscreen layer 310 will comprise a lower voltage level. Conversely, since the touch originating at point 1120 is initially located closer to the second electrical contact 326 of the lower touchscreen layer 320 (which is operably coupled to the supply voltage during the Y-scan), the voltage signal (V_{XP}) initially measured at the second electrical contact 316 of the upper touchscreen layer 310 will comprise a higher voltage level.

However, during the multiple touch gesture, the touch originating at point 1110 moves away from the first electrical contact 324 of the lower touchscreen layer 320 and towards the second electrical 326 of the lower touchscreen layer 320. As a result, the voltage level of the voltage signal (V_{XN}) measured at the first electrical contact 314 of the upper touchscreen layer 310 will increase. Conversely, the touch originating at point 1120 moves away from the second electrical contact 326 of the lower touchscreen layer 320 and towards the first electrical contact 324 of the lower touchscreen layer 320. As a result, the voltage level of the voltage signal (V_{XP}) measured at the second electrical contact 316 of the upper touchscreen layer 310 will decrease. Significantly, during the multiple touch gesture, the order of the two touches with respect to, in the case of the example illustrated in FIG. 11, the y-axis is switched, and at the point of crossing where the order of the two touches switches with respect to the y-axis, the voltages (V_{XN}), (V_{XP}) measured at the first and second electrical contacts 314, 316 of the upper touchscreen layer 310 will be equal. After the order of the two touches has switched with respect to the y-axis, the voltage signal (V_{XN}) measured at the first electrical contact 314 of the upper touchscreen layer 310 will comprise a higher voltage level, whilst the voltage signal (V_{XP}) measured at the second electrical contact 316 of the upper touchscreen layer 310 will comprise a lower voltage level.

Accordingly, the DSP 370 may be arranged to obtain a plurality of measurements for each of the voltage signals (V_{XN}), (V_{XP}) at the electrical contacts 314, 316 of the upper touchscreen layer 310 over a period of time. The DSP 370 may then be arranged to identify that the detected user interaction comprises two clockwise rotating touches if (V_{XP}−V_{XN})>0 at a start of the period of time, and (V_{XP}−V_{XN})<0 at an end of the period of time.

For the example illustrated in FIG. 12, when the switches 340, 342, 344, 346 of the touchscreen apparatus 300 are configured in the Y-scan configuration, since the touch originating at point 1210 is initially located closer to the second electrical contact 326 of the lower touchscreen layer 320 (which is operably coupled to a supply voltage during the Y-scan), the voltage signal (V_{XN}) initially measured at the first electrical contact 314 of the upper touchscreen layer 310 will comprise a higher voltage level. Conversely, since the touch originating at point 1220 is initially located closer to the first electrical contact 324 of the lower touchscreen layer 320 (which is operably coupled to ground during the Y-scan), the voltage signal (V_{XP}) initially measured at the second electrical contact 316 of the upper touchscreen layer 310 will comprise a lower voltage level.

However, during the multiple touch gesture, the touch originating at point 1210 moves away from the second electrical contact 326 of the lower touchscreen layer 320 and towards the first electrical 324 of the lower touchscreen layer 320. As a result, the voltage level of the voltage signal (V_{XN}) measured at the first electrical contact 314 of the upper touchscreen layer 310 will decrease. Conversely, the touch originating at point 1220 moves away from the first electrical contact 324 of the lower touchscreen layer 320 and towards the second electrical contact 326 of the lower touchscreen layer 320. As a result, the voltage level of the voltage signal (V_{XP}) measured at the second electrical contact 316 of the upper touchscreen layer 310 will increase. After the order of the two touches has switched with respect to the y-axis, the voltage signal (V_{XN}) measured at the first electrical contact 314 of the upper touchscreen layer 310 will comprise a lower voltage level, whilst the voltage signal (V_{XP}) measured at the second electrical contact 316 of the upper touchscreen layer 310 will comprise a higher voltage level.

Accordingly, the DSP 370 may be arranged to obtain a plurality of measurements for each of the voltage signals (V_{XN}), (V_{XP}) at the electrical contacts 314, 316 of the upper touchscreen layer 310 over a period of time. The DSP 370 may then be arranged to identify that the detected user interaction comprises two counter clockwise rotating touches if (V_{XP}−V_{XN})<0 at a start of the period of time and (V_{XP}−V_{XN})>0 at an end of the period of time.

Such rotational multiple touch gestures as illustrated in FIGS. 11 and 12 may additionally/alternatively be identified by detecting the crossing of the touches with respect to the y-axis when the switches 340, 342, 344, 346 of the touchscreen apparatus 300 are configured in the X-scan configuration such that a voltage is applied across the upper touchscreen layer 310. For example, and referring back to FIG. 11, since the touch originating at point 1110 is initially located closer to the first electrical contact 324 of the lower touchscreen layer 320, a voltage signal (V_{YN}) measured at the first electrical contact 324 initially provides an indication of the position of the touch originating at point 1110 with respect to the x-axis, whilst a voltage signal (V_{YP}) measured at the second electrical contact 326 of the lower touchscreen layer 320 initially provides an indication of the position of the touch originating at point 1120 with respect to the x-axis. Since the touch originating at point 1110 is located closer to the first electrical contact 314 of the upper touchscreen layer 310 (which is operably coupled to ground during the X-scan), the voltage signal (V_{YN}) measured at the first electrical contact 324 of the lower touchscreen layer 320 will initially comprise a lower voltage level. Conversely, since the touch originating at point 1120 is located closer to the second electrical contact 316 of the upper touchscreen layer 310 (which is operably coupled to the supply voltage during the Y-scan), the voltage signal (V_{YP}) measured at the second electrical contact 326 of the lower touchscreen layer 320 will initially comprise a higher voltage level.

However, during the multiple touch gesture, the touch originating at point 1110 moves away from the first electrical contact 324 of the lower touchscreen layer 320 and towards the second electrical contact 326 of the lower touchscreen layer 320. Conversely, the touch originating at point 1120 moves away from the second electrical contact 326 of the lower touchscreen layer 320 and towards the first electrical contact 324 of the lower touchscreen layer 320. After the order of the two touches has switched with respect to the y-axis, the voltage signal (V_{YN}) measured at the first electrical contact 324 of the lower touchscreen layer 320 will have switched to providing an indication of the position of the touch originating at point 1120 with respect to the x-axis, and thus will subsequently comprise a higher voltage level. Similarly, the voltage signal (V_{YP}) measured at the second electrical contact 326 of the lower touchscreen layer 320 will have switched to providing an indication of the position of the touch originating at point 1110 with respect to the x-axis, and thus will subsequently comprise a lower voltage level.

Accordingly, the DSP 370 may be arranged to obtain a plurality of measurements for each of the voltage signals (V_{YN}), (V_{YP}) at the first and second electrical contacts 324, 326 of the lower touchscreen layer 320 over a period of time. The DSP 370 may then be arranged to identify that the detected user interaction comprises two clockwise rotating touches if (V_{YP}−V_{YN})>0 at a start of the period of time and (V_{YP}−V_{YN})<0 at an end of the period of time.

For the example illustrated in FIG. 12, when the switches 340, 342, 344, 346 of the touchscreen apparatus 300 are configured in the X-scan configuration, since the touch originating at point 1210 is initially located closer to the second electrical contact 326 of the lower touchscreen layer 320, a voltage signal (V_{YP}) measured at the second electrical contact 326 initially provides an indication of the position of the touch originating at point 1210 with respect to the x-axis. A voltage signal (V_{YN}) measured at the first electrical contact 324 of the lower touchscreen layer 320 initially provides an indication of the position of the touch originating at point 1220 with respect to the x-axis. Since the touch originating at point 1210 is located closer to the first electrical contact 314 of the upper touchscreen layer 310 (which is operably coupled to ground during the X-scan), the voltage signal (V_{YP}) measured at the second electrical contact 326 of the upper touchscreen layer 320 will initially comprise a lower voltage level. Conversely, since the touch originating at point 1220 is located closer to the second electrical contact 316 of the upper touchscreen layer 310 (which is operably coupled to the supply voltage during the Y-scan), the voltage signal (V_{YN}) measured at the first electrical contact 324 of the lower touchscreen layer 320 will initially comprise a higher voltage level.

However, during the multiple touch gesture, the touch originating at point 1210 moves away from the second electrical contact 326 of the lower touchscreen layer 320 and towards the first electrical contact 324 of the lower touchscreen layer 320. Conversely, the touch originating at point 1220 moves away from the first electrical contact 324 of the lower touchscreen layer 320 and towards the second electrical contact 326 of the lower touchscreen layer 320. After the order of the two touches has switched with respect to the y-axis, the voltage signal (V_{YP}) measured at the second electrical contact 326 of the lower touchscreen layer 320 will have switched to providing an indication of the position of the touch originating at point 1220 with respect to the x-axis, and thus will subsequently comprise a higher voltage level. Similarly, the voltage signal (V_{YN}) measured at the first electrical contact 324 of the lower touchscreen layer 320 will have switched to providing an indication of the position of the touch originating at point 1210 with respect to the x-axis, and thus will subsequently comprise a lower voltage level.

Accordingly, the DSP 370 may be arranged to obtain a plurality of measurements for each of the voltage signals (V_{YN}), (V_{YP}) at the electrical contacts 324, 326 of the lower touchscreen layer 320 over a period of time. The DSP 370 may then be arranged to identify that the detected user interaction comprises two clockwise rotating touches if (V_{YP}−V_{YN})<0 at a start of the period of time and (V_{YP}−V_{YN})>0 at an end of the period of time.

For the examples illustrated in FIGS. 11 and 12, the user interaction comprises two rotating touches orientated such that the touches ‘cross’ with respect to the y-axis, and the identification of the rotational touches has been based around detecting the crossing of the touches with respect to the y-axis. In accordance with alternative examples of the present invention, user interaction may comprise two rotating touches orientated such that the touches ‘cross’ with respect to the x-axis.

For example, FIG. 13 illustrates an example of a plan view of a multiple touch gesture applied to the touchscreen device 305 where the multiple touch gesture comprises two touches originating at points 1310, 1320, and initially orientated in a diagonal manner with point 1310 being located at a generally upper left location and with point 1320 being located at a generally lower right location. The two touches comprise a movement whereby the first touch originating at point 1310 moves in a generally left to right direction whilst the second touch originating at point 1320 moves in a generally right to left direction, such that the touches are subsequently orientated in an opposing diagonal manner with the touch originating at point 1310 being subsequently located at a generally upper right location and the touch originating at point 1320 being subsequently located at a generally lower left location, such as may be generally representative of a partial rotation of the touches in a general clockwise direction. As illustrated in FIG. 13, the touch originating at point 1310 is located closer to the second electrical contact 326 of the lower touchscreen layer 320 and the touch originating at point 1320 is located closer to the first electrical contact 324 of the lower touchscreen layer 320. Furthermore, the touch originating at point 1310 is initially located closer to the first electrical contact 314 of the upper touchscreen layer 310 and subsequently moves towards the second electrical contact 316 of the upper touchscreen layer 310, whilst the touch originating at point 1320 is initially located closer to the second electrical contact 316 of the upper touchscreen layer 310 and subsequently moves towards the first electrical contact 314 of the upper touchscreen layer 310.

Such rotational multiple touch gestures as illustrated in FIG. 13 may be identified by detecting the crossing of the touches with respect to the x-axis when the switches 340, 342, 344, 346 of the touchscreen apparatus 300 are configured in the X-scan configuration such that a voltage is applied across the upper touchscreen layer 310. The voltage signal (V_{YP}) measured at the second electrical contact 326 of the lower touchscreen layer 320 initially comprises a lower voltage value representative of an initial position of the touch originating at point 1310, with the voltage value for the voltage signal (V_{YP}) measured at the second electrical contact 326 increasing as the touch originating at point 1310 moves from left to right. Conversely, voltage signal (V_{YN}) measured at the first electrical contact 324 of the lower touchscreen layer 320 initially comprises a higher voltage value representative of the initial position of the touch originating at point 1320, with the voltage value for the voltage signal (V_{YN}) measured at the first electrical contact 324 decreasing as the touch originating at point 1320 moves from right to left.

During the multiple touch gesture, the order of the two touches with respect to, in the case of the example illustrated in FIG. 13, the x-axis is switched, and at the point of crossing where the order of the two touches switches with respect to the x-axis, the voltages (V_{YN}), (V_{YP}) measured at the first and second electrical contacts 324, 326 of the lower touchscreen layer 320 will be equal. After the order of the two touches has switched with respect to the x-axis, the voltage signal (V_{YN}) measured at the first electrical contact 324 of the lower touchscreen layer 320 will comprise a lower voltage level, whilst the voltage signal (V_{YP}) measured at the second electrical contact 326 of the lower touchscreen layer 320 will comprise a higher voltage level.

Accordingly, the DSP 370 may be arranged to obtain a plurality of measurements for each of the voltage signals (V_{YN}), (V_{YP}) at the electrical contacts 324, 326 of the lower touchscreen layer 320 over a period of time. The DSP 370 may then be arranged to identify that the detected user interaction comprises two clockwise rotating touches if (V_{YP}−V_{YN})<0 at a start of the period of time and (V_{YP}−V_{YN})>0 at an end of the period of time.

Such rotational multiple touch gestures as illustrated in FIG. 13 may additionally/alternatively be identified by detecting the crossing of the touches with respect to the x-axis when the switches 340, 342, 344, 346 of the touchscreen apparatus 300 are configured in the Y-scan configuration such that a voltage is applied across the lower touchscreen layer 320. In this case, the DSP 370 may be arranged to obtain a plurality of measurements for each of the voltage signals (V_{XN}), (V_{XP}) at the electrical contacts 314, 316 of the upper touchscreen layer 310 over a period of time. The DSP 370 may then be arranged to identify that the detected user interaction comprises two clockwise rotating touches if (V_{XP}−V_{XN})<0 at a start of the period of time and (V_{XP}−V_{XN})>0 at an end of the period of time.

FIG. 14 illustrates an alternative example of a plan view of a multiple touch gesture applied to the touchscreen device 305 where the multiple touch gesture comprises two touches originating at points 1410, 1420, and initially orientated in a diagonal manner with point 1410 being located at a generally lower left location and with point 1420 being located at a generally upper right location. The two touches comprise a movement whereby the first touch originating at point 1410 moves in a generally left to right direction whilst the second touch originating at point 1420 moves in a generally right to left direction, such that the touches are subsequently orientated in an opposing diagonal manner with the touch originating at point 1410 being subsequently located at a generally lower right location and the touch originating at point 1420 being subsequently located at a generally upper left location, such as may be generally representative of a partial rotation of the touches in a general counter clockwise direction. As illustrated in FIG. 14, the touch originating at point 1410 is located closer to the first electrical contact 324 of the lower touchscreen layer 320 and the touch originating at point 1420 is located closer to the second electrical contact 326 of the lower touchscreen layer 320. Furthermore, the touch originating at point 1410 is initially located closer to the first electrical contact 314 of the upper touchscreen layer 310 and subsequently moves towards the second electrical contact 316 of the upper touchscreen layer 310, whilst the touch originating at point 1420 is initially located closer to the second electrical contact 316 of the upper touchscreen layer 310 and subsequently moves towards the first electrical contact 314 of the upper touchscreen layer 310.

Such rotational multiple touch gestures as illustrated in FIG. 14 may be identified by detecting the crossing of the touches with respect to the x-axis when the switches 340, 342, 344, 346 of the touchscreen apparatus 300 are configured in the X-scan configuration such that a voltage is applied across the upper touchscreen layer 310. The voltage signal (V_{YN}) measured at the first electrical contact 324 of the lower touchscreen layer 320 initially comprises a lower voltage value representative of an initial position of the touch originating at point 1410, with the voltage value for the voltage signal (V_{YN}) measured at the first electrical contact 324 increasing as the touch originating at point 1410 moves from left to right. Conversely, voltage signal (V_{YP}) measured at the second electrical contact 326 of the lower touchscreen layer 320 initially comprises a higher voltage value representative of the initial position of the touch originating at point 1420, with the voltage value for the voltage signal (V_{YP}) measured at the second electrical contact 326 decreasing as the touch originating at point 1420 moves from right to left.

During the multiple touch gesture, the order of the two touches with respect to, in the case of the example illustrated in FIG. 14, the x-axis is switched, and at the point of crossing where the order of the two touches switches with respect to the x-axis, the voltages (V_{YN}), (V_{YP}) measured at the first and second electrical contacts 324, 326 of the lower touchscreen layer 320 will be equal. After the order of the two touches has switched with respect to the x-axis, the voltage signal (V_{YP}) measured at the second electrical contact 326 of the lower touchscreen layer 320 will comprise a lower voltage level, whilst the voltage signal (V_{YN}) measured at the first electrical contact 324 of the lower touchscreen layer 320 will comprise a higher voltage level.

Accordingly, the DSP 370 may be arranged to obtain a plurality of measurements for each of the voltage signals (V_{YN}), (V_{YP}) at the electrical contacts 324, 326 of the lower touchscreen layer 320 over a period of time. The DSP 370 may then be arranged to identify that the detected user interaction comprises two counter clockwise rotating touches if (V_{YP}−V_{YN})>0 at a start of the period of time and (V_{YP}−V_{YN})<0 at an end of the period of time.

Such rotational multiple touch gestures as illustrated in FIG. 14 may additionally/alternatively be identified by detecting the crossing of the touches with respect to the x-axis when the switches 340, 342, 344, 346 of the touchscreen apparatus 300 are configured in the Y-scan configuration such that a voltage is applied across the lower touchscreen layer 320. In this case, the DSP 370 may be arranged to obtain a plurality of measurements for each of the voltage signals (V_{XN}), (V_{XP}) at the electrical contacts 314, 316 of the upper touchscreen layer 310 over a period of time. The DSP 370 may then be arranged to identify that the detected user interaction comprises two clockwise rotating touches if (V_{XP}−V_{XN})>0 at a start of the period of time and (V_{XP}−V_{XN})<0 at an end of the period of time.

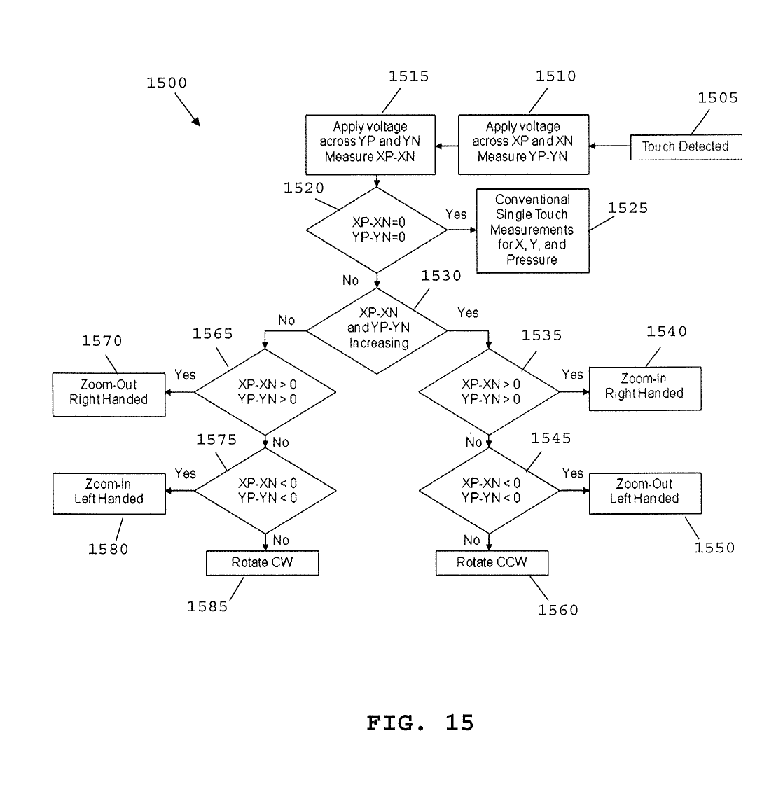

Referring now to FIG. 15, there is illustrated an example of a simplified flowchart 1500 of a method for identifying multiple touch user interaction with a touchscreen device, for example as may be implemented by a signal processing module such as the DSP 370 of FIG. 3.

The method starts at step 1505 with a detection of a touch on the touchscreen device. A first voltage is then applied across a first conductive layer of the touchscreen device and first and second voltage signals at first and second electrical contacts of a second conductive layer of the touchscreen device are measured, at step 1510. A second voltage is then applied across the second conductive layer of the touchscreen device and third and fourth voltage signals at third and fourth electrical contacts of the first conductive layer of the touchscreen device are measured at step 1515. The user interaction with the touchscreen device may then be interpreted based on the measure voltage signals.

In particular, for the illustrated example, a difference between the first and second voltage signals measured at the first and second electrical contacts of the second conductive layer is calculated and a difference between the third and fourth voltage signals measured at the third and fourth electrical contacts of the first conductive layer is calculated in step 1520. If the difference between the first and second voltage signals measured at the first and second electrical contacts of the second conductive layer is negligible AND the difference between the third and fourth voltage signals measured at the third and fourth electrical contacts of the first conductive layer is negligible, it may be determined that the detected user interaction comprises a single touch of the touchscreen device. Accordingly, the method moves on to step 1525, where coordinates for the detected touch may be determined, for example from the measured voltage values, and any other required measurements may be obtained, such as a pressure measurement etc.

Referring back to step 1520, if the first and second measured voltage signals for the second conductive layer are not equal or the third and fourth measured voltage signals for the first conductive layer are not equal, it may be determined that the detected user interaction comprises multiple touches of the touchscreen device. The user interaction may then be interpreted to identify one or more multiple touch gestures based at least partly on the measured voltage signals.

In particular for the illustrated example, at step 1530 the difference between the first and second voltage signals measured at the first and second electrical contacts for the second conductive layer (V_{YP}−V_{YN}) and the difference between the third and fourth voltage signals measured at the third and fourth electrical contacts for the first conductive layer (V_{XP}−V_{XN}) are calculated over a period of time. If the difference between the first and second voltage signals and the third and fourth voltage signals calculated over the period of time are increasing for both sets of voltage signals, the method moves on to step 1535.

At step 1535, if the difference between the first and second voltage signals and the third and fourth voltage signals calculated over the period of time is greater than zero at a start and at an end of the period of time, the method moves to step 1540 where the detected user interaction is identified as comprising two diverging touches (as might be performed by a right hand of a user for a ‘zoom in’ function). Otherwise the method moves to step 1545.

At step 1545, if the difference between the first and second voltage signals and the third and fourth voltage signals calculated over the period of time is less than zero for the first and second conductive layers at the start and at the end of the period of time, the method moves to step 1550 where the detected user interaction is identified as comprising two converging touches (as might be performed by a left hand of a user for a ‘zoom out’ function). Otherwise the method moves to step 1560, where the detected user interaction is identified as comprising two rotating touches.

In particular for the example illustrated in FIG. 15, it is assumed that for user interaction comprising two rotating touches, such rotating touches are orientated such that the touches ‘cross’ with respect to the y-axis. As such the identification of the rotational touches is based around detection of the crossing of the touches with respect to the y-axis. Thus, for the example illustrated in FIG. 15, at step 1560 the detected user interaction is identified as comprising two touches rotating in a counter clockwise direction.

Referring back to step 1530, if the difference between the first and second voltage signals and the third and fourth voltage signals calculated over the period of time are not increasing for both sets of voltage signals, the method moves on to step 1565.

At step 1565, if the difference between the first and second voltage signals and the third and fourth voltage signals calculated over the period of time is greater than zero at the start and at the end of the period of time, the method moves to step 1570 where the detected user interaction is identified as comprising two converging touches (as might be performed by a right hand of a user for a ‘zoom out’ function). Otherwise the method moves on to step 1575.

At step 1575, if the difference between the first and second voltage signals and the third and fourth voltage signals calculated over the period of time is less than zero for the first and second conductive layers at the start and at the end of the period of time, the method moves to step 1580 where the detected user interaction is identified as comprising two diverging touches (as might be performed by a left hand of a user for a ‘zoom in’ function). Otherwise the method moves to step 1585, where the detected user interaction is identified as comprising two rotating touches.

In particular for the example illustrated in FIG. 15, it is assumed that for user interaction comprising two rotating touches, such rotating touches are orientated such that the touches ‘cross’ with respect to the y-axis, and as such the identification of the rotational touches is based around detection of the crossing of the touches with respect to the y-axis. Thus, for the example illustrated in FIG. 15, at step 1585 the detected user interaction is identified as comprising two touches rotating in a clockwise direction. In this manner, if a detected user interaction is identified as comprising two rotating touches, the method comprises determining the direction of rotation of the touches based on whether the difference between the voltage signals measured at the first and second electrical contacts for the first and second conductive layers calculated over the period of time are not increasing or decreasing for both sets of voltage signals.

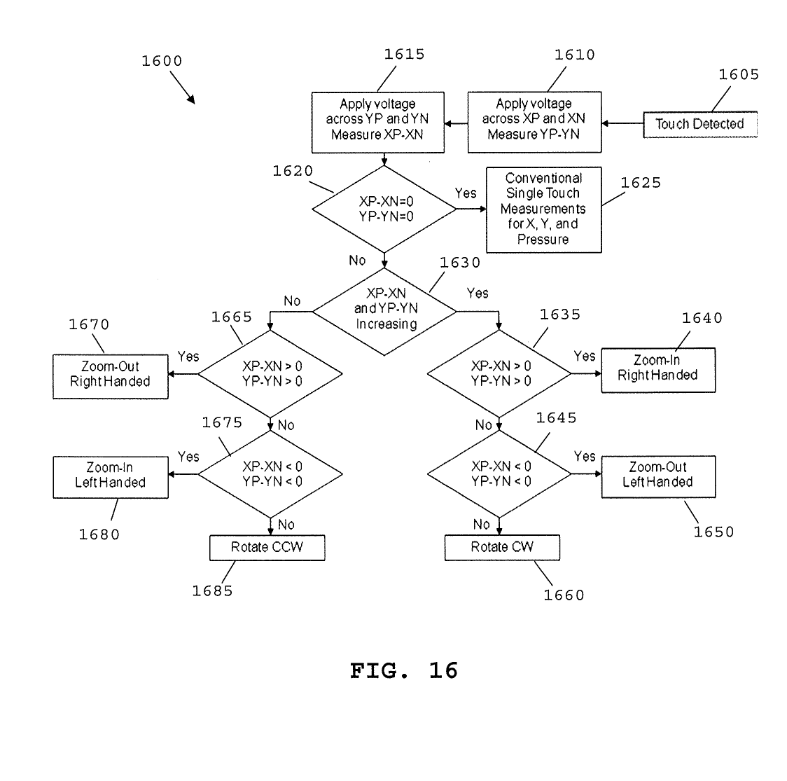

Referring now to FIG. 16, there is illustrated an alternative example of a simplified flowchart 1600 of a method for identifying multiple touch user interaction with a touchscreen device, for example as may be implemented by a signal processing module such as the DSP 370 of FIG. 3. Steps 1605 to 1650 of the method of FIG. 16 are the same as steps 1505 to 1550 of the method of FIG. 15. However, for the example illustrated in FIG. 16, it is assumed that for user interaction comprising two rotating touches, such rotating touches are orientated such that the touches ‘cross’ with respect to the x-axis, and as such the identification of the rotational touches is based around detection of the crossing of the touches with respect to the x-axis. Thus, for the example illustrated in FIG. 16, at step 1660 the detected user interaction is identified as comprising two touches rotating in a clockwise direction. Similarly, steps 1665 to 1680 of the method of FIG. 16 are the same as steps 1565 to 1580 of the method of FIG. 15. However, and as just mentioned, for the example illustrated in FIG. 16 it is assumed that for user interaction comprising two rotating touches, such rotating touches are orientated such that the touches ‘cross’ with respect to the x-axis, and as such the identification of the rotational touches is based around detection of the crossing of the touches with respect to the x-axis. Thus, for the example illustrated in FIG. 16, at step 1685 the detected user interaction is identified as comprising two touches rotating in a counter clockwise direction.

A skilled artisan will appreciate that in other applications, alternative functions/circuits/devices and/or other techniques may be used. For example, whilst for the example illustrated in FIG. 3 the touchscreen apparatus is implemented within a wireless communication unit 300, the inventive concept may equally be applied to a touchscreen apparatus implemented within alternative forms of electronic devices such as, by way of example only, kiosks and automated money machines (ATMs), point of sale (POS) systems, etc. Furthermore, whilst a touchscreen device 305 has been illustrated and described comprising a liquid crystal display (LCD) 330, it is contemplated that the touchscreen device may comprise any form of display device over which touchscreen layers may be provided, such as a light emitting diode (LED) display, cathode ray tube (CRT) display, etc. Furthermore, the display device is not limited to an active display device such as an LCD display, but may comprise a passive display such as a printed presentation of information etc.

Advantageously, the inventive concepts described herein enables a low cost 4-wire resistive touchscreen device to be used within a touchscreen apparatus, requiring only a four terminal (pin) interface with a controller integrated circuit (for example the integrated circuit device 390), whilst also enabling multiple touch gestures to be detected and interpreted based on differential signals.

In some examples, some or all of the steps illustrated in the flowcharts may be implemented in hardware and/or some or all of the steps illustrated in the flowchart may be implemented in software.

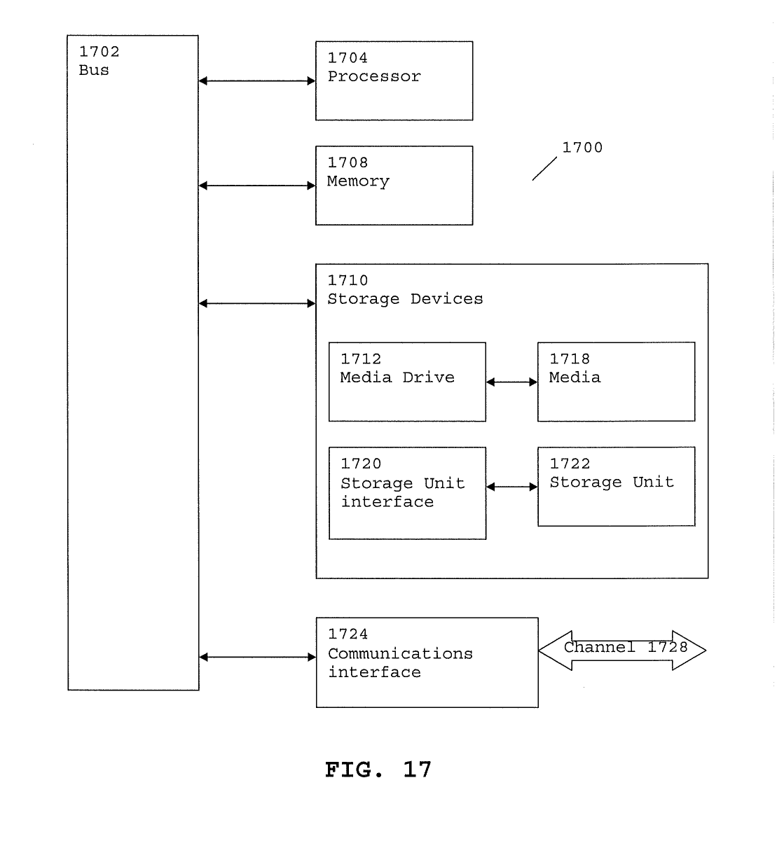

Referring now to FIG. 17, there is illustrated a typical computing system 1700 that may be employed to implement signal processing functionality in embodiments of the invention. Computing systems of this type may be used in access points and wireless communication units. Those skilled in the relevant art will also recognize how to implement the invention using other computer systems or architectures. Computing system 1700 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 1700 can include one or more processors, such as a processor 1704. Processor 1704 can be implemented using a general or special-purpose processing engine such as, for example, a microprocessor, microcontroller or other control module. In this example, processor 1704 is connected to a bus 1702 or other communications medium.

Computing system 1700 can also include a main memory 1708, such as random access memory (RAM) or other dynamic memory, for storing information and instructions to be executed by processor 1704. Main memory 1708 also may be used for storing temporary variables or other intermediate information during execution of instructions to be executed by processor 1704. Computing system 1700 may likewise include a read only memory (ROM) or other static storage device coupled to bus 1702 for storing static information and instructions for processor 1704.

The computing system 1700 may also include information storage system 1710, which may include, for example, a media drive 1712 and a removable storage interface 1720. The media drive 1712 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 1718 may include, for example, a hard disk, floppy disk, magnetic tape, optical disk, CD or DVD, or other fixed or removable medium that is read by and written to by media drive 1712. As these examples illustrate, the storage media 1718 may include a computer-readable storage medium having particular computer software or data stored therein.

In alternative embodiments, information storage system 1710 may include other similar components for allowing computer programs or other instructions or data to be loaded into computing system 1700. Such components may include, for example, a removable storage unit 1722 and an interface 1720, such as a program cartridge and cartridge interface, a removable memory (for example, a flash memory or other removable memory module) and memory slot, and other removable storage units 1722 and interfaces 1720 that allow software and data to be transferred from the removable storage unit 1718 to computing system 1700.

Computing system 1700 can also include a communications interface 1724. Communications interface 1724 can be used to allow software and data to be transferred between computing system 1700 and external devices. Examples of communications interface 1724 can include a modem, a network interface (such as an Ethernet or other NIC card), a communications port (such as for example, a universal serial bus (USB) port), a PCMCIA slot and card, etc. Software and data transferred via communications interface 1724 are in the form of signals which can be electronic, electromagnetic, and optical or other signals capable of being received by communications interface 1724. These signals are provided to communications interface 1724 via a channel 1728. This channel 1728 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’ ‘computer-readable medium’ and the like may be used generally to refer to media such as, for example, memory 1708, storage device 1718, or storage unit 1722. These and other forms of computer-readable media may store one or more instructions for use by processor 1704, to cause the processor to perform specified operations. Such instructions, generally referred to as ‘computer program code’ (which may be grouped in the form of computer programs or other groupings), when executed, enable the computing system 1700 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 1700 using, for example, removable storage drive 1722, drive 1712 or communications interface 1724. The control module (in this example, software instructions or computer program code), when executed by the processor 1704, causes the processor 1704 to perform the functions of the invention as described herein.

In particular, it is envisaged that the aforementioned inventive concept can be applied by a semiconductor manufacturer to any integrated circuit comprising signal processing functionality arranged to detect and interpret user interaction with a touchscreen device. It is further envisaged that, for example, a semiconductor manufacturer may employ the inventive concept in a design of a stand-alone device, such as a digital signal processor (DSP) or microcontroller, or application-specific integrated circuit (ASIC) and/or any other sub-system element.

It will be appreciated that, for clarity purposes, the above description has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices. Thus, the elements and components of an embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Thus, an improved touchscreen apparatus and method of operation therefor have been described, wherein the aforementioned disadvantages with prior art arrangements have been substantially alleviated.

1. A method for identifying multiple touch user interaction with a touchscreen device, the method comprising:
receiving an indication that a touch has been detected on the touchscreen device;
applying a first voltage across a first conductive layer of the touchscreen device and measuring first and second voltage signals at first and second electrical contacts of a second conductive layer of the touchscreen device;
applying a second voltage across the second conductive layer of the touchscreen device and measuring third and fourth voltage signals at third and fourth electrical contacts of the first conductive layer of the touchscreen device; and
interpreting the user interaction with the touchscreen device and identifying multiple touch gestures based at least partly on at least one of:
i. a difference between the first and second voltage signals measured at the first and second electrical contacts of the second conductive layer; and
ii. a difference between the third and fourth voltage signals measured at the third and fourth electrical contacts of the first conductive layer.

2. The method of claim 1 wherein the method comprises:
applying the first voltage across the third and fourth contacts of the first conductive layer of the touchscreen device in a first direction;
measuring the first voltage signal (V_{YP}) at the first electrical contact of the second conductive layer;
measuring the second voltage signal (V_{YN}) at the second electrical contact of the second conductive layer;
applying the second voltage across first and second electrical contacts of the second conductive layer of the touchscreen device in a second direction transverse to the first direction;
measuring the third voltage signal (V_{XP}) at the third electrical contact of the first conductive layer; and
measuring the fourth voltage signal (V_{XN}) at the fourth electrical contact of the first conductive layer.

3. The method of claim 2 wherein the method further comprises:
calculating a first difference between the first and second voltage signals measured at the first and second electrical contacts of the second conductive layer; and
calculating a second difference between the third and fourth voltage signals measured at the third and fourth electrical contacts of the first conductive layer; and
if an absolute value of the difference between the first and second voltage signals measured at the first and second electrical contacts of the second conductive layer is below a threshold value and the absolute value of the difference between the third and fourth voltage signals measured at the third and fourth electrical contacts of the first conductive layer is below a threshold value, determining that the detected user interaction comprises a single touch of the touchscreen device.

4. The method of claim 3 wherein, if it is determined that the detected user interaction comprises a single touch of the touchscreen device, the method comprises calculating coordinates for the single touch based on the measured voltages.

5. The method of claim 2 further comprising obtaining a plurality of measurements for a number of the first, second, third or fourth voltage signals over a period of time and identifying, based at least partly on the measured voltage signals over the period of time, at least one of: two diverging touches;
two converging touches; and
two rotating touches.

6. The method of claim 5 wherein the method comprises:
determining whether the results of (V_{XP}−V_{XN}) and (V_{YP}−V_{YN}) over the period of time are increasing; and
if the results of (V_{XP}−V_{XN}) and (V_{YP}−V_{YN}) over the period of time are increasing, determining whether at a start and at an end of the period of time (V_{XP}−V_{XN})>0 and (V_{YP}−V_{YN})>0; and
if at the start and at the end of the period of time (V_{XP}−V_{XN})>0 and (V_{YP}−V_{YN})>0, identifying that the detected user interaction comprises two diverging touches.

7. The method of claim 5 wherein the method comprises:
determining whether the results of (V_{XP}−V_{XN}) and (V_{YP}−V_{YN}) over the period of time are increasing; and
if the results of (V_{XP}−V_{XN}) and (V_{YP}−V_{YN}) over the period of time are increasing, determining whether at a start and at an end of the period of time (V_{XP}−V_{XN})<0 and (V_{YP}−V_{YN})<0; and
if (V_{XP}−V_{XN})<0 and (V_{YP}−V_{YN})<0 throughout the period of time, identifying that the detected user interaction comprises two converging touches.

8. The method of claim 5 wherein the method comprises:
determining whether the results of (V_{XP}−V_{XN}) and (V_{YP}−V_{YN}) over the period of time are decreasing; and
if the results of (V_{XP}−V_{XN}) and (V_{YP}−V_{YN}) over the period of time are decreasing, determining whether at a start and at an end of the period of time (V_{XP}−V_{XN})>0 and (V_{YP}−V_{YN})>0; and
if at the start and at the end of the period of time (V_{XP}−V_{XN})>0 and (V_{YP}−V_{YN})>0, identifying that the detected user interaction comprises two converging touches.

9. The method of claim 5 wherein the method comprises:
determining whether the results of (V_{XP}−V_{XN}) and (V_{YP}−V_{YN}) over the period of time are decreasing; and
if the results of (V_{XP}−V_{XN}) and (V_{YP}−V_{YN}) over the period of time are decreasing, determining whether at a start and at an end of the period of time (V_{XP}−V_{XN})<0 and (V_{YP}−V_{YN})<0; and
if at the start and at the end of the period of time (V_{XP}−V_{XN})<0 and (V_{YP}−V_{YN})<0, identifying that the detected user interaction comprises two diverging touches.

10. The method of claim 5 wherein the method comprises identifying that the detected user interaction comprises two rotating touches if at least one of the following conditions is true:
(V_{XP}−V_{XN})<0 at a start of the period of time and (V_{XP}−V_{XN})>0 at an end of the period of time;
(V_{XP}−V_{XN})>0 at a start of the period of time and (V_{XP}−V_{XN})<0 at an end of the period of time;
(V_{YP}−V_{YN})<0 at a start of the period of time and (V_{YP}−V_{YN})>0 at an end of the period of time; and
(V_{YP}−V_{YN})>0 at a start of the period of time and (V_{YP}−V_{YN})<0 at an end of the period of time.

11. The method of claim 10 wherein, if a detected user interaction is identified as comprising two rotating touches, the method comprises determining a direction of rotation of the touches based on whether the results of (V_{XP}−V_{XN}) and (V_{YP}−V_{YN}) over the period of time are increasing or decreasing.

12. An integrated circuit device comprising a signal processing module arranged to identify multiple touch user interaction with a touchscreen device, the signal processing module being arranged to:
receive an indication that a touch has been detected on the touchscreen device;
apply a first voltage across a first conductive layer of the touchscreen device and receive a measurement for first and second voltage signals at first and second electrical contacts of a second conductive layer of the touchscreen device;
apply a second voltage across the second conductive layer of the touchscreen device and receive measurements for third and fourth voltage signals at third and fourth electrical contacts of the first conductive layer of the touchscreen device; and
interpret the user interaction with the touchscreen device and identify multiple touch gestures based at least partly on at least one of:
i. a difference between the first and second voltage signals measured at the first and second electrical contacts of the second conductive layer; and
ii. a difference between the third and fourth voltage signals measured at the third and fourth electrical contacts of the first conductive layer.

13. An electronic device comprising a touchscreen device and a signal processing module arranged to identify multiple touch user interaction with a touchscreen device, the signal processing module being arranged to:
receive an indication that a touch has been detected on the touchscreen device;
apply a first voltage across a first conductive layer of the touchscreen device and receive a measurement for first and second voltage signals at first and second electrical contacts of a second conductive layer of the touchscreen device;
apply a second voltage across the second conductive layer of the touchscreen device and receive measurements for third and fourth voltage signals at third and fourth electrical contacts of the first conductive layer of the touchscreen device; and
interpret the user interaction with the touchscreen device and identify multiple touch gestures based at least partly on at least one of:
i. a difference between the first and second voltage signals measured at the first and second electrical contacts of the second conductive layer; and
ii. a difference between the third and fourth voltage signals measured at the third and fourth electrical contacts of the first conductive layer.
